(19) United States
(12) Patent Application Publication
(10) Pub. No.: US 2025/0303882 A1
(43) Pub. Date: Oct. 2, 2025

(54) POWER SUPPLY APPARATUS, ELECTRICALLY-POWERED VEHICLE INCLUDING THE SAME, AND POWER STORAGE DEVICE

(71) Applicant: TOYOTA JIDOSHA KABUSHIKI KAISHA, Toyota-shi (JP)

(72) Inventors: Manabu SASAKI, Hashima-shi (JP); Hiroyuki TAKAHASHI, Miyoshi-shi (JP)

(73) Assignee: TOYOTA JIDOSHA KABUSHIKI KAISHA, Toyota-shi (JP)

(21) Appl. No.: 19/052,639

(22) Filed: Feb. 13, 2025

(30) Foreign Application Priority Data
Mar. 29, 2024 (JP) 2024-055619

(51) Int. Cl. B60L 50/64; B60K 1/04; B60L 50/60; H01M 50/202

(52) U.S. Cl. CPC B60L 50/64; B60K 1/04; B60L 50/66; H01M 50/202

(57) ABSTRACT

In a power supply apparatus, a connector accommodation portion can accommodate a connector portion. In the connector portion, a connection surface faces a second direction and is provided with a first terminal, a first side surface faces a third direction, a second side surface faces a fourth direction, a first inclined surface connects the first side surface to the connection surface, and a second inclined surface connects the second side surface to the connection surface. In the connector accommodation portion, a facing surface faces the connection surface in an accommodation state in which the power storage device is accommodated in the housing portion, is provided with a second terminal, a first side wall portion faces the first side surface in the accommodation state, and a second side wall portion faces the second side surface in the accommodation state.

### CROSS REFERENCE TO RELATED APPLICATIONS

This nonprovisional application is based on Japanese Patent Application No. 2024-055619 filed on Mar. 29, 2024 with the Japan Patent Office, the entire contents of which are hereby incorporated by reference.

### BACKGROUND

### Field

The present disclosure relates to a power supply apparatus, an electrically-powered vehicle including the same, and a power storage device.

### Description of the Background Art

Japanese Patent Laying-Open No. 2013-209040 discloses that a battery unit is detachably attached to a battery compartment of a vehicle body. Japanese Patent Laying-Open No. 2013-209040 also describes the following.

The battery unit has an electrode connector projecting rearwardly from a rear end face thereof. A rear end portion (bottom portion in an insertion direction) in the battery compartment is provided with an abutment wall against which the rear end portion of the battery unit abuts when the battery unit is housed in the battery compartment. A feeder connector of the vehicle body is integrally assembled to the abutment wall at a place opposite to the electrode connector of the battery unit. The fitting portions of the electrode connector and the feeder connector are formed with tapered surfaces such as to ensure that terminals of these connectors are reliably interconnected in spite of some vertical or transverse displacement between these connectors.

### SUMMARY

In the conventional battery unit and battery compartment, terminals may come into contact with each other while being insufficiently aligned by the tapered surfaces. This may damage the terminals.

The present disclosure has been made in view of the problem described above. An object of the present disclosure is to provide a power supply apparatus and a power storage device that can suppress damage to terminals due to contact between these terminals that are insufficiently misaligned.

A power supply apparatus according to a first aspect of the present disclosure includes a power storage device and a housing portion. The housing portion can be mounted in an apparatus that uses the power storage device as a power supply. The housing portion detachably accommodates the power storage device. The power storage device includes a power storage body portion and a connector portion. The connector portion is provided outside the power storage body portion. The connector portion includes a first terminal electrically connected to the power storage body portion. The housing portion includes a body accommodation portion and a connector accommodation portion. The body accommodation portion has an opening that is open toward a first direction. The body accommodation portion detachably accommodates the power storage body portion through the opening. The connector accommodation portion has an accommodation space communicating with an accommodation space of the body accommodation portion. The connector accommodation portion accommodates the connector portion. The connector accommodation portion includes a second terminal fittable with the first terminal of the accommodated connector portion. The connector portion includes a connection surface, a first side surface, a second side surface, a first inclined surface, and a second inclined surface. The connection surface faces a second direction opposite to the first direction and is provided with the first terminal. The first side surface faces a third direction intersecting the second direction and extending along a horizontal direction. The second side surface faces a fourth direction opposite to the third direction. The first inclined surface connects the first side surface to the connection surface. The second inclined surface connects the second side surface to the connection surface. The connector accommodation portion includes a facing surface, a first side wall portion, and a second side wall portion. The facing surface faces the connection surface in an accommodation state in which the power storage device is accommodated in the housing portion, and is provided with the second terminal. The first side wall portion faces the first side surface in the accommodation state. The second side wall portion faces the second side surface in the accommodation state. A dimension (Wfro) of the connection surface in the third direction is smaller than a distance (Wsid) in the third direction between the first side wall portion and the second side wall portion. A dimension (L1) in the second direction from a tip of the first terminal in the second direction to an end edge of the first side surface in the second direction is smaller than a dimension (L5) in the first direction from a tip of the second terminal in the first direction to a top edge of the first side wall portion in the first direction. A dimension (L3) in the second direction from the tip of the first terminal in the second direction to a top edge of the second side surface in the second direction is smaller than a dimension (L6) in the first direction from the tip of the second terminal in the first direction to a top edge of the second side wall portion in the first direction. A dimension (Wwid) in the third direction between the first side surface and the second side surface is substantially equal to the distance (Wsid) in the third direction between the first side wall portion and the second side wall portion. The first side surface and the second side surface extend parallel to the first direction. An inner surface of the first side wall portion and an inner surface of the second side wall portion extend parallel to the first direction. The first terminal and/or the second terminal extends parallel to the first direction.

With the configuration described above, during insertion of the power storage body portion into the body accommodation portion through the opening, even when the power storage body portion is misaligned with the body accommodation portion in the third direction or the fourth direction, the dimension (Wfro) described above is smaller than the distance (Wsid) described above, thus allowing the connector portion to easily enter between the first side wall portion and the second side wall portion. When the power storage device is further pushed in the second direction after the entrance of the connector portion with the misalignment described above, the connector portion is displaced such that the first inclined surface slides on the top edge of the first side wall portion. Alternatively, the connector portion is displaced such that the second inclined surface slides on the top edge of the second side wall portion. As a result, the connector portion is aligned with the connector accommodation portion in the third direction and the fourth direction. Since the dimension (L1) described above is smaller than the dimension (L5) described above and the dimension (L3) described above is smaller than the dimension (L6) described above, this alignment is complete before the first terminal and the second terminal come into contact with each other. Further, since the dimension (Wwid) described above is substantially equal to the distance (Wsid) described above, the first side surface and the second side surface extend parallel to the first direction, and the inner surface of the first side wall portion and the inner surface of the second side wall portion extend parallel to the first direction, the connector portion can be displaced while being aligned with the connector accommodation portion. Since the first terminal and/or the second terminal extends parallel to the first direction, the first terminal and the second terminal are fitted with each other by pushing the power storage device further in the second direction. This can suppress damage to the first terminal and the second terminal due to contact between these terminals that are insufficiently aligned.

A power supply apparatus according to a second aspect of the present disclosure includes a power storage device and a housing portion. The housing portion can be mounted in an apparatus that uses the power storage device as a power supply. The housing portion detachably accommodates the power storage device. The power storage device includes a power storage body portion and a connector portion. The connector portion is provided outside the power storage body portion. The connector portion includes a first terminal electrically connected to the power storage body portion. The housing portion includes a body accommodation portion and a connector accommodation portion. The body accommodation portion has an opening that is open toward a first direction. The body accommodation portion detachably accommodates the power storage body portion through the opening. The connector accommodation portion has an accommodation space communicating with an accommodation space of the body accommodation portion. The connector accommodation portion accommodates the connector portion. The connector accommodation portion includes a second terminal fittable with the first terminal of the accommodated connector portion. The connector portion includes a connection surface, a first side surface, a second side surface, a first inclined surface, and a second inclined surface. The connection surface faces a second direction opposite to the first direction and is provided with the first terminal. The first side surface faces a third direction intersecting the second direction and extending along a horizontal direction. The second side surface faces a fourth direction opposite to the third direction. The first inclined surface connects the first side surface to the connection surface. The second inclined surface connects the second side surface to the connection surface. The connector accommodation portion includes a facing surface, a first side wall portion, and a second side wall portion. The facing surface faces the connection surface in an accommodation state in which the power storage device is accommodated in the housing portion, and is provided with the second terminal. The first side wall portion faces the first side surface in the accommodation state. The second side wall portion faces the second side surface in the accommodation state. The connector accommodation portion further includes a minimum width region in which a distance in the third direction between the first side wall portion and the second side wall portion is the smallest. A dimension (Wfro) of the connection surface in the third direction is smaller than a distance (Wnar) between the first side wall portion and the second side wall portion in the minimum width region. A dimension (L1) in the second direction from a tip of the first terminal in the second direction to an end edge of the first side surface in the second direction and a dimension (L3) in the second direction from the tip of the first terminal in the second direction to a top edge of the second side surface in the second direction are smaller than a dimension (L15) in the first direction from a tip of the second terminal in the first direction to a top edge of the minimum width region in the first direction. A dimension (Wwid) in the third direction between the first side surface and the second side surface is substantially equal to the distance (Wnar) between the first side wall portion and the second side wall portion in the minimum width region. The first side surface and the second side surface extend parallel to the first direction. In the minimum width region, an inner surface of the first side wall portion and an inner surface of the second side wall portion extend parallel to the first direction. The first terminal and/or the second terminal extends parallel to the first direction.

With the configuration described above, during insertion of the power storage body portion into the body accommodation portion through the opening, even when the power storage body portion is misaligned with the body accommodation portion in the third direction or the fourth direction, the dimension (Wfro) described above is smaller than the distance (Wnar) described above, thus allowing the connector portion to easily enter between the first side wall portion and the second side wall portion. When the power storage device is further pushed in the second direction after the entrance of the connector portion with the misalignment, the connector portion is displaced such that the first inclined surface slides on the top edge of the first side wall portion in the first direction in the minimum width region. Alternatively, the connector portion is displaced such that the second inclined surface slides on the top edge of the second side wall portion in the first direction in the minimum width region. As a result, the connector portion is aligned with the connector accommodation portion in the third direction and the fourth direction. Since the dimension (L1) described above and the dimension (L3) described above are smaller than the dimension (L15) described above, this alignment is complete before the first terminal and the second terminal come into contact with each other. Further, since the dimension (Wwid) described above is substantially equal to the distance (Wnar) described above, the first side surface and the second side surface extend parallel to the first direction, and the inner surface of the first side wall portion and the inner surface of the second side wall portion extend parallel to the first direction in the minimum width region, the connector portion can be displaced while being aligned with the connector accommodation portion. Since the first terminal and/or the second terminal extends parallel to the first direction, the first terminal and the second terminal are fitted with each other by pushing the power storage device further in the second direction. This can suppress damage to the first terminal and the second terminal due to contact between these terminals that are insufficiently aligned.

A power supply apparatus according to a third aspect of the present disclosure includes a power storage device and a housing portion. The housing portion can be mounted in an apparatus that uses the power storage device as a power supply. The housing portion detachably accommodates the power storage device. The power storage device includes a power storage body portion and a connector portion. The connector portion is provided outside the power storage body portion. The connector portion includes a first terminal electrically connected to the power storage body portion. The housing portion includes a body accommodation portion and a connector accommodation portion. The body accommodation portion has an opening that is open toward a first direction. The body accommodation portion detachably accommodates the power storage body portion through the opening. The connector accommodation portion has an accommodation space communicating with an accommodation space of the body accommodation portion. The connector accommodation portion accommodates the connector portion. The connector accommodation portion includes a second terminal fittable with the first terminal of the accommodated connector portion. The connector portion includes a connection surface, a first side surface, a second side surface, a first inclined surface, and a second inclined surface. The connection surface faces a second direction opposite to the first direction and is provided with the first terminal. The first side surface faces a third direction intersecting the second direction and extending along a horizontal direction. The second side surface faces a fourth direction opposite to the third direction. The first inclined surface connects the first side surface to the connection surface. The second inclined surface connects the second side surface to the connection surface. The connector accommodation portion includes a facing surface, a first side wall portion, and a second side wall portion. The facing surface faces the connection surface in an accommodation state in which the power storage device is accommodated in the housing portion, and is provided with the second terminal. The first side wall portion faces the first side surface in the accommodation state. The second side wall portion faces the second side surface in the accommodation state. The connector accommodation portion further includes a minimum width region in which a distance in the third direction between the first side wall portion and the second side wall portion is the smallest. A dimension (Wfro) of the connection surface in the third direction is smaller than a distance (Wbot) between the first side wall portion and the second side wall portion in the minimum width region. The connector portion further includes a maximum width region in which a dimension of the connector portion in the third direction is the largest. A dimension (L1) in the second direction from a tip of the first terminal in the second direction to a top edge of the maximum width region in the second direction is smaller than a dimension (L25) in the first direction from a tip of the second terminal in the first direction to the minimum width region. A dimension (Wwid) of the connector portion in the third direction in the maximum width region is substantially equal to the distance (Wbot) between the first side wall portion and the second side wall portion in the minimum width region. The first side surface and the second side surface extend parallel to the first direction. The first terminal and/or the second terminal extends parallel to the first direction.

With the configuration described above, during insertion of the power storage body portion into the body accommodation portion through the opening, even when the power storage body portion is misaligned with the body accommodation portion in the third direction or the fourth direction, the dimension (Wfro) described above is smaller than the distance (Wbot) described above, thus allowing the connector portion to easily enter between the first side wall portion and the second side wall portion. When the power storage device is further pushed in the second direction after the entrance of the connector portion with the misalignment, the connector portion is displaced such that the first inclined surface slides on the first side wall portion in the minimum width region. Alternatively, the connector portion is displaced such that the second inclined surface slides on the top edge of the second side wall portion in the minimum width region. As a result, the connector portion is aligned with the connector accommodation portion in the third direction and the fourth direction. Since the dimension (L1) described above is smaller than the dimension (L25) described above, this alignment is complete before the first terminal and the second terminal come into contact with each other. Further, since the dimension (Wwid) described above is substantially equal to the distance (Wbot) described above, and the first side surface and the second side surface extend parallel to the first direction, the connector portion can be displaced while being aligned with the connector accommodation portion. Since the first terminal and/or the second terminal extends parallel to the first direction, the first terminal and the second terminal are fitted with each other by pushing the power storage device further in the second direction. This can suppress damage to the first terminal and the second terminal due to contact between these terminals that are insufficiently aligned.

A power supply apparatus according to a fourth aspect of the present disclosure includes a power storage device and a housing portion. The housing portion can be mounted in an apparatus that uses the power storage device as a power supply. The housing portion detachably accommodates the power storage device. The power storage device includes a power storage body portion and a connector portion. The connector portion is provided outside the power storage body portion. The connector portion includes a first terminal electrically connected to the power storage body portion. The housing portion includes a body accommodation portion and a connector accommodation portion. The body accommodation portion has an opening that is open toward a first direction. The body accommodation portion detachably accommodates the power storage body portion through the opening. The connector accommodation portion has an accommodation space communicating with an accommodation space of the body accommodation portion. The connector accommodation portion accommodates the connector portion. The connector accommodation portion includes a second terminal fittable with the first terminal of the accommodated connector portion. The connector portion includes a connection surface, a first side surface, a second side surface, a first inclined surface, and a second inclined surface. The connection surface faces a second direction opposite to the first direction and is provided with the first terminal. The first side surface faces a third direction intersecting the second direction and extending along a horizontal direction. The second side surface faces a fourth direction opposite to the third direction. The first inclined surface connects the first side surface to the connection surface. The second inclined surface connects the second side surface to the connection surface. The connector accommodation portion includes a facing surface, a first side wall portion, and a second side wall portion. The facing surface faces the connection surface in an accommodation state in which the power storage device is accommodated in the housing portion, and is provided with the second terminal. The first side wall portion faces the first side surface in the accommodation state. The second side wall portion faces the second side surface in the accommodation state. A dimension (Wfro) of the connection surface in the third direction is smaller than a distance (Wsid) in the third direction between the first side wall portion and the second side wall portion. The connector portion further includes a maximum width region in which a dimension of the connector portion in the third direction is the largest. A distance (L1) in the first direction from a tip of the first terminal in the second direction to the maximum width region is smaller than a dimension (L5) in the first direction from a tip of the second terminal in the first direction to a top edge of the first side wall portion in the first direction. The distance (L1) in the first direction from the tip of the first terminal in the second direction to the maximum width region is smaller than a dimension (L6) in the first direction from the tip of the second terminal in the first direction to a top edge of the second side wall portion in the first direction. A dimension (Wwid) of the connector portion in the third direction in the maximum width region is substantially equal to the distance (Wsid) in the third direction between the first side wall portion and the second side wall portion. An inner surface of the first side wall portion and an inner surface of the second side wall portion extend parallel to the first direction. The first terminal and/or the second terminal extends parallel to the first direction.

With the configuration described above, during insertion of the power storage body portion into the body accommodation portion through the opening, even when the power storage body portion is misaligned with the body accommodation portion in the third direction or the fourth direction, the dimension (Wfro) described above is smaller than the distance (Wsid) described above, thus allowing the connector portion to easily enter between the first side wall portion and the second side wall portion. When the power storage device is further pushed in the second direction after the entrance of the connector portion with the misalignment, the connector portion is displaced such that the first inclined surface slides on the top edge of the first side wall portion. Alternatively, the connector portion is displaced such that the second inclined surface slides on the top edge of the second side wall portion. As a result, the connector portion is aligned with the connector accommodation portion in the third direction and the fourth direction. Since the dimension (L1) described above is smaller than the dimension (L5) described above and the dimension (L1) described above is smaller than the dimension (L6) described above, this alignment is complete before the first terminal and the second terminal come into contact with each other. Further, since the dimension (Wwid) described above is substantially equal to the distance (Wsid) described above, and the inner surface of the first side surface and the inner surface of the second side surface extend parallel to the first direction, the connector portion can be displaced while being aligned with the connector accommodation portion. Since the first terminal and/or the second terminal extends parallel to the first direction, the first terminal and the second terminal are fitted with each other by pushing the power storage device further in the second direction. This can suppress damage to the first terminal and the second terminal due to contact between these terminals that are insufficiently aligned.

A power supply apparatus according to a fifth aspect of the present disclosure includes a power storage device and a housing portion. The housing portion can be mounted in an apparatus that uses the power storage device as a power supply. The housing portion detachably accommodates the power storage device. The power storage device includes a power storage body portion and a connector portion. The connector portion is provided outside the power storage body portion. The connector portion includes a first terminal electrically connected to the power storage body portion. The housing portion includes a body accommodation portion and a connector accommodation portion. The body accommodation portion has an opening that is open toward a first direction. The body accommodation portion detachably accommodates the power storage body portion through the opening. The connector accommodation portion has an accommodation space communicating with an accommodation space of the body accommodation portion. The connector accommodation portion accommodates the connector portion. The connector accommodation portion includes a second terminal fittable with the first terminal of the accommodated connector portion. The connector portion includes a connection surface, a first side surface, a second side surface, a first inclined surface, and a second inclined surface. The connection surface faces a second direction opposite to the first direction and is provided with the first terminal. The first side surface faces a third direction intersecting the second direction and extending along a horizontal direction. The second side surface faces a fourth direction opposite to the third direction. The first inclined surface connects the first side surface to the connection surface. The second inclined surface connects the second side surface to the connection surface. The connector accommodation portion includes a facing surface, a first side wall portion, and a second side wall portion. The facing surface faces the connection surface in an accommodation state in which the power storage device is accommodated in the housing portion, and is provided with the second terminal. The first side wall portion faces the first side surface in the accommodation state. The second side wall portion faces the second side surface in the accommodation state. The connector accommodation portion further includes a minimum width region in which a distance in the third direction between the first side wall portion and the second side wall portion is the smallest. A dimension (Wfro) of the connection surface in the third direction is smaller than a distance (Wnar) between the first side wall portion and the second side wall portion in the minimum width region. The connector portion further includes a maximum width region in which a dimension of the connector portion in the third direction is the largest. A distance (L1) in the first direction from a tip of the first terminal in the second direction to the maximum width region is smaller than a dimension (L15) in the first direction from the tip of the second terminal in the first direction to a top edge of the minimum width region in the first direction. A dimension (Wwid) of the connector portion in the third direction in the maximum width region is substantially equal to the distance (Wnar) between the first side wall portion and the second side wall portion in the minimum width region. In the minimum width region, an inner surface of the first side wall portion and an inner surface of the second side wall portion extend parallel to the first direction. The first terminal and/or the second terminal extends parallel to the first direction.

With the configuration described above, during insertion of the power storage body portion into the body accommodation portion through the opening, even when the power storage body portion is misaligned with the body accommodation portion in the third direction or the fourth direction, the dimension (Wfro) described above is smaller than the distance (Wnar) described above, thus allowing the connector portion to easily enter between the first side wall portion and the second side wall portion. When the power storage device is further pushed in the second direction after the entrance of the connector portion with the misalignment, the connector portion is displaced such that the first inclined surface slides on the top edge of the first side wall portion in the first direction in the minimum width region. Alternatively, the connector portion is displaced such that the second inclined surface slides on the top edge of the second side wall portion in the first direction in the minimum width region. As a result, the connector portion is aligned with the connector accommodation portion in the third direction and the fourth direction. Since the dimension (L1) described above is smaller than the dimension (L15) described above, this alignment is complete before the first terminal and the second terminal come into contact with each other. Further, since the dimension (Wwid) described above is substantially equal to the distance (Wnar) described above, and the inner surface of the first side wall portion and the inner surface of the second side wall portion extend parallel to the first direction, the connector portion can be displaced while being aligned with the connector accommodation portion. Since the first terminal and/or the second terminal extends parallel to the first direction, the first terminal and the second terminal are fitted with each other by pushing the power storage device further in the second direction. This can suppress damage to the first terminal and the second terminal due to contact between these terminals that are insufficiently aligned.

In the power supply apparatus according to each of the first to fifth aspects of the present disclosure, preferably, the first side wall portion and the second side wall portion are provided so as not to face the connection surface in the first direction during accommodation of the power storage device in the housing portion through the opening.

The configuration described above can more reliably bring the first inclined surface into contact with the top edge of the first side wall portion or the second inclined surface into contact with the top edge of the second side wall portion.

In the power supply apparatus according to each of the first to fifth aspects of the present disclosure, preferably, the top edge of the first side wall portion in the first direction is contiguous to the opening. The top edge of the second side wall portion in the first direction is contiguous to the opening.

With the configuration described above, the space between the first side wall portion and the second side wall portion, which is the accommodation space of the connector accommodation portion, can be visually recognized easily from the first direction side. This allows the first terminal of the connector portion to be more reliably fitted with the second terminal of the connector accommodation portion.

In the power supply apparatus according to each of the first to fifth aspects of the present disclosure, preferably, the second terminal projects toward the first direction. The first terminal is recessed from the connection surface toward the first direction, and is configured to be fittable with the second terminal corresponding thereto. The first terminal includes a pair of receiving wall portions. The pair of receiving wall portions face each other in the third direction, and extend from the connection surface toward the first direction. The pair of receiving wall portions extend so as to have a smaller distance in the third direction toward the first direction.

With the configuration described above, during accommodation of the power storage device in the housing portion, the second terminal can be easily fitted into the first terminal as the second terminal comes into contact with the pair of receiving wall portions.

In the power supply apparatus according to each of the first to fifth aspects of the present disclosure, preferably, the power storage device further includes a lever. The lever is pivotably supported by the power storage body portion or the connector portion. The lever includes a guide rail. The housing portion further includes a guide pin. The guide pin projects from the body accommodation portion or the connector accommodation portion in a direction orthogonal to the second direction. The guide rail includes an inlet groove and a curved groove. The inlet groove extends in the second direction when the lever is in a first state. The inlet groove allows the guide pin to enter the inlet groove during housing of the power storage device in the housing portion. The curved groove extends from the inlet groove in a pivot direction of the lever. The lever is configured to pivot from the first state to a second state to urge the curved groove in the second direction while further moving, relative to the guide rail, the guide pin that has entered the inlet groove through the curved groove.

With the configuration described above, the worker causes the lever to pivot to urge the curved groove in the second direction, and consequently, urge the power storage device in the second direction. This allows the worker to accommodate the power storage device in the housing portion with a relatively small force.

In the power supply apparatus according to each of the first to fifth aspects of the present disclosure, preferably, the guide rail further includes an extension groove. The extension groove extends, in the second state, from an end of the curved groove opposite to an inlet groove side in a direction intersecting the second direction. The lever is configured to slide from the second state in a direction opposite to a direction of extension of the extension groove from the curved groove to cause the guide pin to enter the extension groove from the curved groove relative to the guide rail.

With the configuration described above, the guide pin is fixed in the first direction by the extension groove. This can suppress accidental detachment of the housed power storage device from the housing portion.

An electrically-powered vehicle according to another aspect of the present disclosure includes the power supply apparatus according to any one of the first to fifth aspects. With the configuration described above, the electrically-powered vehicle can use the power supply apparatus as a power supply.

A power storage device according to still another aspect of the present disclosure can be accommodated in a housing portion that is open toward a first direction, and is accommodated in the housing portion to be electrically connectable to a terminal provided in the housing portion. The power storage device includes a power storage body portion and a connector portion. The connector portion is provided outside the power storage body portion. The connector portion is electrically connected to the power storage body portion. The connector portion includes a first terminal fittable with the terminal provided in the housing portion. The connector portion includes a connection surface, a first inclined surface, a second inclined surface, a first side surface, and a second side surface. The connection surface faces a second direction opposite to the first direction. The connection surface is provided with the first terminal. The first inclined surface extends, from an end edge of the connection surface in a third direction so as to be inclined in the third direction toward the first direction. The third direction intersects the second direction and extends along a horizontal direction. The second inclined surface extends, from an end edge of the connection surface in a fourth direction opposite to the third direction, so as to be inclined in the fourth direction toward the first direction. The first side surface extends along the first direction from an end edge of the first inclined surface in the first direction. The second side surface extends along the first direction from an end edge of the second inclined surface in the first direction.

During accommodation of the power storage device in the housing portion in the second direction, the power storage device may be misaligned with the housing portion in the third direction or the fourth direction. With the configuration described above, during the accommodation, the first inclined surface or the second inclined surface of the connector portion can be brought into contact with the housing portion. When the power storage device is pushed in the second direction in this state, the power storage device can be displaced in the third direction or the fourth direction. Thus, the misalignment of the power storage device with the housing portion can be corrected. When the power storage device is further pushed in the second direction after the correction of the misalignment, at least one of the first side surface and the second side surface can be brought into sliding contact with the housing portion. When the power storage device is pushed in the second direction in this state, displacement of the power storage device in the third direction and the fourth direction can be suppressed. Thus, the first terminal that is displaced in the second direction can be electrically connected to the terminal of the housing portion while its displacement in the third direction and the fourth direction is being suppressed. During accommodation of the power storage device in the housing portion, thus, damage to the first terminal or the terminal of the housing portion can be suppressed.

In the power storage device according to still another aspect of the present disclosure, preferably, a dimension in the second direction from the end edge of the first inclined surface in the first direction to a tip of the first terminal in the second direction is smaller than a dimension in the first direction from a tip of the first terminal in the first direction to a top edge of the first side surface in the first direction. A dimension in the second direction from the end edge of the second inclined surface in the first direction to the tip of the first terminal in the second direction is smaller than a dimension in the first direction from the tip of the first terminal in the first direction to a top edge of the second side surface in the first direction.

With the configuration described above, the first side surface and the second side surface have a relatively large length in the first direction. During insertion of the power storage device into the housing portion in the second direction, thus, at least one of the first side surface and the second side surface is in sliding contact with the housing portion for a relatively long period of time. Consequently, displacement of the power storage device is suppressed in the third direction and the fourth direction for a longer period of time. As a result, damage to the first terminal or the terminal of the housing portion can be suppressed more during accommodation of the power storage device in the housing portion.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic diagram showing an example electrically-powered vehicle in which a power supply apparatus according to Embodiment 1 is mounted.

FIG. 2 is a perspective view of the power supply apparatus according to Embodiment 1.

FIG. 3 is a partial plan view of the power supply apparatus according to Embodiment 1.

FIG. 4 is a partial sectional view of the power supply apparatus of FIG. 3, as viewed from the direction of the arrow IV-IV.

FIG. 5 is a perspective view showing the state of the power storage device being attached to or detached from a housing portion in Embodiment 1.

FIG. 6 is a plan view showing the state of the power storage device being attached to or detached from the housing portion in Embodiment 1.

FIG. 7 is a partial sectional view showing the state of FIG. 6, as viewed from the direction of the arrow VII-VII.

FIG. 8 is a perspective view showing a connector portion and its vicinity of the power storage device in Embodiment 1.

FIG. 9 is a partial plan view of a power supply apparatus according to Modification 1 of Embodiment 1.

FIG. 10A is a partial perspective view of a power supply apparatus according to Modification 2 of Embodiment 1, FIG. 10B is a partial plan view of a power supply apparatus according to Modification 3 of Embodiment 1, FIG. 10C is a partial plan view of a power supply apparatus according to Modification 4 of Embodiment 1, FIG. 10D is a partial plan view of a power supply apparatus according to Modification 5 of Embodiment 1, FIG. 10E is a partial plan view of a power supply apparatus according to Modification 6 of Embodiment 1, and FIG. 10F is a partial plan view of a power supply apparatus according to Modification 7 of Embodiment 1.

FIG. 11 is a partial perspective view of a power storage device according to Embodiment 2.

FIG. 12 is an exploded perspective view of the power storage device according to Embodiment 2 with a lever disassembled.

FIG. 13 is a plan view showing the state of the power storage device being attached to or detached from a housing portion in Embodiment 2.

FIG. 14 is a partial sectional view showing the state of FIG. 13, as viewed from the direction of the arrow XIV-XIV.

FIG. 15 is a partial sectional view of a power supply apparatus when the lever is in a first state in Embodiment 2.

FIG. 16 is a partial sectional view showing the state of the lever changing from the first state in FIG. 15 to a second state.

FIG. 17 is a partial sectional view of the power supply apparatus when the lever is in the second state in Embodiment 2.

FIG. 18 is a partial sectional view of the power supply apparatus when the lever is in a third state in Embodiment 2.

FIG. 19 is a perspective view showing the state of a power storage device being attached to or detached from a housing portion in Embodiment 3.

FIG. 20 is a partial plan view showing the state of the power storage device being attached to or detached from the housing portion in Embodiment 3.

FIG. 21 is a partial plan view of the power supply apparatus when the lever is in the first state in Embodiment 3.

FIG. 22 is a partial plan view of the power supply apparatus when the lever is in the second state in Embodiment 3.

FIG. 23 is a perspective view of a connector portion and its vicinity of a power storage device in Embodiment 4.

FIG. 24 is a partial sectional view of the power supply apparatus when the lever is in the third state in Embodiment 4.

FIG. 25 is a functional block diagram schematically showing an example circuit in the power supply apparatus according to Embodiment 4.

FIG. 26 is a functional block diagram schematically showing another example circuit in the power supply apparatus according to Embodiment 4.

FIG. 27 is a partial perspective view of a power storage device according to Embodiment 5.

FIG. 28 is an exploded perspective view of the power storage device according to Embodiment 5 with a lever disassembled.

FIG. 29 is a partial sectional view of a power supply apparatus when the lever is in the third state in Embodiment 5.

### DESCRIPTION OF THE PREFERRED EMBODIMENTS

A power storage device, a power supply apparatus, and a vehicle according to each embodiment of the present disclosure will be described with reference to the accompanying drawings. In the drawings, the same or corresponding portions are denoted by the same reference characters, and description thereof will not be repeated.

### Embodiment 1

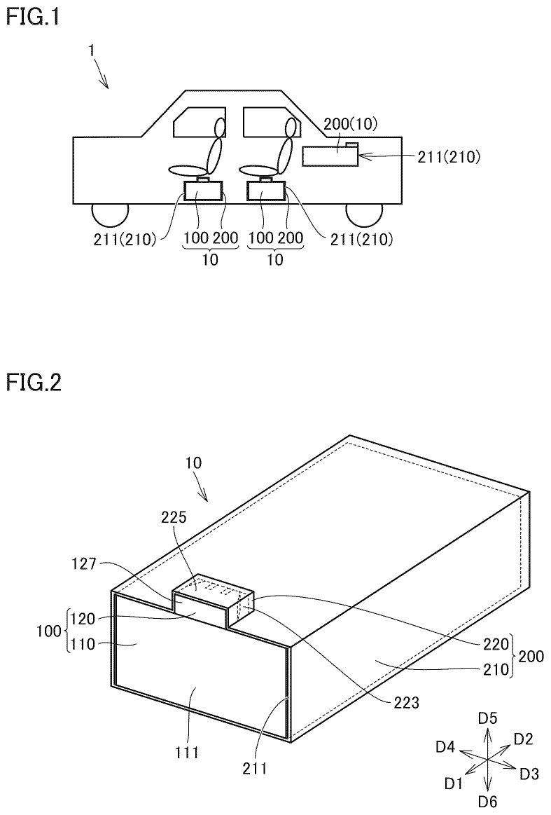

FIG. 1 is a schematic diagram showing an example electrically-powered vehicle in which a power supply apparatus according to Embodiment 1 is mounted. FIG. 2 is a perspective view of the power supply apparatus according to Embodiment 1.

As shown in FIG. 1, an electrically-powered vehicle 1 according to Embodiment 1 of the present disclosure includes a power supply apparatus 10. Electrically-powered vehicle 1 can thus use power supply apparatus 10 as a power supply. Electrically-powered vehicle 1 is, for example, a battery electric vehicle (BEV). Electrically-powered vehicle 1 may be another type of electrically-powered vehicle, such as a plug-in hybrid electric vehicle (PHEV).

Power supply apparatus 10 includes a power storage device 100 and a housing portion 200. Housing portion 200 can be mounted in an apparatus that can use power storage device 100 as a power supply. As shown in FIG. 1, housing portion 200 can be mounted in electrically-powered vehicle 1. Housing portion 200 detachably accommodates power storage device 100. Power storage device 100 is thus mounted in electrically-powered vehicle 1. Electrically-powered vehicle 1 can use power storage device 100 as a power supply. In other words, electrically-powered vehicle 1 is operated by power storage device 100.

As shown in FIG. 1, housing portion 200 may be mounted under the vehicle seat. The seat may be a front seat and/or a rear seat. Housing portion 200 may be mounted in the rear portion of the vehicle. Housing portion 200 may be mounted behind the rear seat.

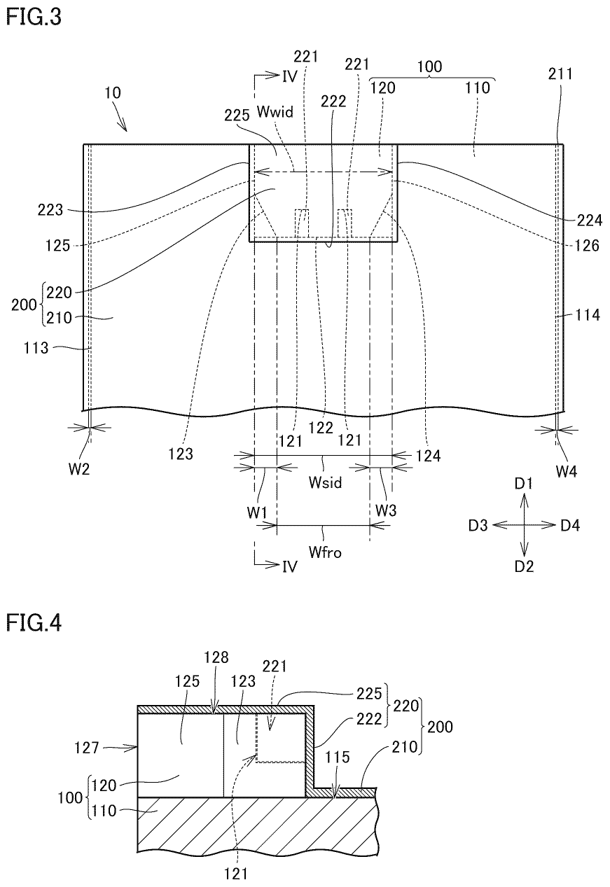

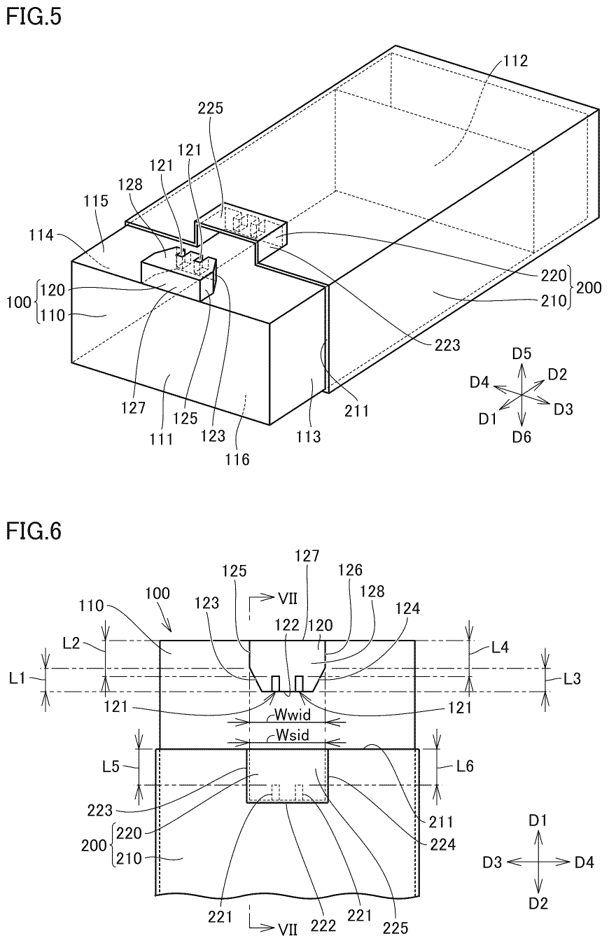

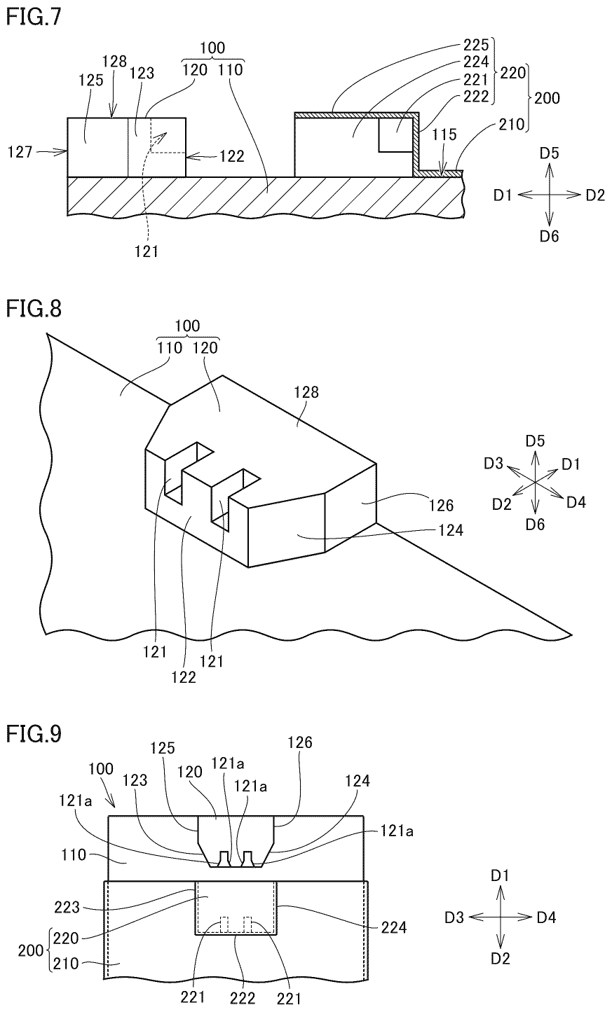

FIG. 3 is a partial plan view of the power supply apparatus according to Embodiment 1. FIG. 4 is a partial sectional view of the power supply apparatus of FIG. 3, as viewed from the direction of the arrow IV-IV. FIG. 5 is a perspective view showing the state of the power storage device being attached to or detached from a housing portion in Embodiment 1. FIG. 6 is a plan view showing the state of the power storage device being attached to or detached from the housing portion in Embodiment 1. FIG. 7 is a partial sectional view showing the state of FIG. 6, as viewed from the direction of the arrow VII-VII. FIG. 8 is a perspective view showing a connector portion and its vicinity of the power storage device in Embodiment 1.

As shown in FIGS. 2 to 8, power storage device 100 is configured to be accommodated in housing portion 200 that is open toward a first direction D1. Power storage device 100 is configured to be housed in housing portion 200 to be electrically connectable to a terminal provided in housing portion 200.

Power storage device 100 includes a power storage body portion 110 and a connector portion 120. Power storage body portion 110 typically includes one or more power storage modules (not shown) and a case that houses the one or more power storage modules. Each power storage module typically includes a plurality of cells. Each cell is, for example, a battery, and may be a non-aqueous electrolyte secondary battery such as a lithium-ion secondary battery. The cells may be electrically connected to each other.

The shape of power storage body portion 110 is not particularly limited, but typically has the outer shape of an approximately rectangular parallelepiped. Power storage body portion 110 has a first surface 111, a second surface 112, a third surface 113, a fourth surface 114, a fifth surface 115, and a sixth surface 116. In the accommodation state in which power storage device 100 is accommodated in housing portion 200, these surfaces face first direction D1, a second direction D2, a third direction D3, a fourth direction D4, a fifth direction D5, and a sixth direction D6, respectively.

First direction D1 is a direction that intersects the vertical direction. First direction D1 is preferably the direction extending along the horizontal direction. Second direction D2 is the direction opposite to first direction D1. Third direction D3 is the direction intersecting second direction D2 and extending along the horizontal direction. Third direction D3 is preferably the direction orthogonal to second direction D2. Fourth direction D4 is the direction opposite to third direction D3. Fifth direction D5 is the direction facing upward and different from first direction D1 and second direction D2. Fifth direction D5 is preferably orthogonal to both first direction D1 and third direction D3. Sixth direction D6 is the direction opposite to fifth direction D5.

Also in the following description, the directions are those when power storage device 100 is accommodated in housing portion 200.

Connector portion 120 is provided outside power storage body portion 110. Specifically, connector portion 120 is provided on fifth surface 115. This allows connector portion 120 to be visually recognized relatively easily when power storage device 100 is attached or detached. It is also preferable that connector portion 120 be provided on the first direction D1 side on fifth surface 115. In this way, when power storage device 100 is attached or detached, it is preferable that connector portion 120 be provided so as to be in contact with the corner formed by first surface 111 and fifth surface 115. Connector portion 120 may be provided on second surface 112, third surface 113, fourth surface 114, or sixth surface 116.

Connector portion 120 has a first terminal 121. First terminal 121 is configured to be fittable with a terminal provided in housing portion 200. First terminal 121 is electrically connected to power storage body portion 110. Specifically, first terminal 121 is electrically connected to the power storage module accommodated in power storage body portion 110. More specifically, first terminal 121 is electrically connected to each cell within the power storage module.

Connector portion 120 has two first terminals 121. First terminals 121 are aligned while being separated from each other in third direction D3. One of first terminals 121 is electrically connected to the positive electrode of power storage body portion 110. The other first terminal 121 is electrically connected to the negative electrode of power storage body portion 110. The positive electrode and negative electrode of power storage body portion 110 are electrically connected to the positive electrode and negative electrode, respectively, of at least one power storage module. The positive electrode and negative electrode of the power storage module are electrically connected to the positive electrode and negative electrode, respectively, of at least one cell in the power storage module. In the following description, when the configuration of a single first terminal 121 is merely described, at least one of the two first terminals 121 may have this configuration, or both the two first terminals 121 may have this configuration.

Connector portion 120 has a connection surface 122, a first inclined surface 123, a second inclined surface 124, a first side surface 125, a second side surface 126, a back surface 127, and a top surface 128.

Connection surface 122 faces second direction D2. Connection surface 122 is provided with first terminal 121. First terminal 121 is recessed from connection surface 122 toward first direction D1. In the present embodiment, first terminal 121 is open on the side opposite to power storage body portion 110. In other words, first terminal 121 is open in fifth direction D5.

First inclined surface 123 extends from the end edge of connection surface 122 in third direction D3 so as to be inclined in third direction D3 toward first direction D1. First inclined surface 123 connects first side surface 125 to connection surface 122. Second inclined surface 124 extends from the end edge of connection surface 122 in fourth direction D4 so as to be inclined in fourth direction D4 toward first direction D1. Second inclined surface 124 connects second side surface 126 to connection surface 122.

First side surface 125 faces third direction D3. First side surface 125 extends along first direction D1 from the end edge of first inclined surface 123 in first direction D1. Second side surface 126 faces fourth direction D4. Second side surface 126 extends along first direction D1 from the end edge of second inclined surface 124 in first direction D1.

As shown in FIG. 6, during accommodation of power storage device 100 in housing portion 200 in second direction D2, power storage device 100 may be misaligned with housing portion 200 in third direction D3 or fourth direction D4. In this case, according to the configuration described above, first inclined surface 123 or second inclined surface 124 of connector portion 120 may come into contact with accommodation portion 200 during the accommodation. When power storage device 100 is pushed in second direction D2 in this state, power storage device 100 may be displaced in third direction D3 or fourth direction D4. Thus, the misalignment of power storage device 100 with housing portion 200 can be corrected. Subsequently, when power storage device 100 is pushed further in second direction D2 after the correction of the misalignment, at least one of first side surface 125 and second side surface 126 can be brought into sliding contact with housing portion 200. When power storage device 100 is pushed in second direction D2 in this state, the displacement of power storage device 100 in third direction D3 and fourth direction D4 can be suppressed. Thus, first terminal 121, which is displaced in second direction D2, can be electrically connected to the terminal of housing portion 200 with suppressed displacement in third direction D3 and fourth direction D4. This suppresses damage to first terminal 121 or the terminal of housing portion 200 during accommodation of power storage device 100 in housing portion 200.

As shown in FIG. 6, a dimension L1 in second direction D2 from the end edge of first inclined surface 123 in first direction D1 to the tip of first terminal 121 in second direction D2 is smaller than a dimension L2 in first direction D1 from the tip of first terminal 121 in first direction D1 to the top edge of first side surface 125 in first direction D1. A dimension L3 in second direction D2 from the end edge of second inclined surface 124 in first direction D1 to the tip of first terminal 121 in second direction D2 is smaller than a dimension LA in first direction D1 from the tip of first terminal 121 in first direction D1 to the top edge of second side surface 126 in first direction D1.

With the configuration described above, first side surface 125 and second side surface 126 have a relatively large length in first direction D1. Thus, during pushing of power storage device 100 into housing portion 200 in second direction D2, a period of time for which at least one of first side surface 125 and second side surface 126 is in sliding contact with housing portion 200 becomes relatively long. Consequently, a period of time for which displacement of power storage device 100 in third direction D3 and fourth direction D4 is suppressed also becomes longer. Thus, damage to first terminal 121 or the terminal of housing portion 200 is more suppressed during accommodation of power storage device 100 in housing portion 200.

Back surface 127 connects the end edge of first side surface 125 and the end edge of second side surface 126 in first direction D1. Back surface 127 faces first direction D1.

As shown in FIGS. 2 to 8, housing portion 200 has a body accommodation portion 210 and a connector accommodation portion 220.

Body accommodation portion 210 has an opening 211. Opening 211 is open toward first direction D1. Body accommodation portion 210 detachably accommodates power storage body portion 110 through opening 211.

As shown in FIG. 1, opening 211 may face one direction of the vehicle's width directions (the left and right directions) of electrically-powered vehicle 1 or may face the rear of electrically-powered vehicle 1. In other words, first direction D1 may be either one direction of the vehicle's width directions (the left and right directions) of electrically-powered vehicle 1, or may be the rear direction of electrically-powered vehicle 1.

Body accommodation portion 210 may also have a lid (not shown) that covers opening 211 so as to open and close opening 211. Also, as shown in FIGS. 2 to 8, with power storage device 100 being housed in housing portion 200, second surface 112, third surface 113, fourth surface 114, and fifth surface 115 may or may not be held in contact with body accommodation portion 210. In the accommodation state, sixth surface 116 is held in contact with body accommodation portion 210. When power storage device 100 is attached to or detached from housing portion 200, sixth surface 116 slides on the inner surface of body accommodation portion 210.

Connector accommodation portion 220 has an accommodation space that communicates with the accommodation space of body accommodation portion 210. Connector accommodation portion 220 accommodates connector portion 120.

Connector accommodation portion 220 has a second terminal 221. Second terminal 221 is fittable with first terminal 121 of connector portion 120 accommodated in housing portion 200. First terminal 121 and/or second terminal 221 extends parallel to first direction D1. In the present embodiment, both first terminal 121 and second terminal 221 extend parallel to first direction D1. Second terminal 221 projects from the accommodation space side of connector accommodation portion 220 toward first direction D1. First terminal 121 is configured to allow its corresponding second terminal 221 to fit thereinto. Connector accommodation portion 220 has two second terminals 221. The two first terminals 121 are configured such that the two second terminals 221 are respectively fittable into the two first terminals 121.

With housing portion 200 being mounted in electrically-powered vehicle 1, second terminals 221 are further electrically connectable to the driving components of electrically-powered vehicle 1, such as a motor. Thus, as first terminals 121 are inserted into second terminals 221, power storage device 100 and the driving components of electrically-powered vehicle 1 are electrically connectable to each other via first terminals 121 and second terminals 221.

Connector accommodation portion 220 has a facing surface 222, a first side wall portion 223, a second side wall portion 224, and an upper wall portion 225.

Facing surface 222 faces connection surface 122 in the accommodation state. Facing surface 222 is provided with second terminals 221. The part of facing surface 222 except for second terminals 221 may or may not be held in contact with connection surface 122.

First side wall portion 223 faces first side surface 125 in the accommodation state. First side wall portion 223 extends along first direction D1 from the end edge of facing surface 222 in third direction D3. First side wall portion 223 also faces first inclined surface 123 in the accommodation state.

The top edge of first side wall portion 223 in first direction D1 is contiguous to opening 211. The top edge of first side wall portion 223 in first direction D1 is aligned with opening 211 in first direction D1.

Second side wall portion 224 faces second side surface 126 in the accommodation state. Second side wall portion 224 extends along first direction D1 from the end edge of facing surface 222 in fourth direction D4. Second side wall portion 224 also faces second inclined surface 124 in the accommodation state.

The top edge of second side wall portion 224 in first direction D1 is contiguous to opening 211. The top edge of second side wall portion 224 in first direction D1 is aligned with opening 211 in first direction D1.

In the present embodiment, facing surface 222, first side wall portion 223, and second side wall portion 224 extend from body accommodation portion 210 on the fifth direction D5 side of body accommodation portion 210. This can suppress accumulation of a liquid such as water in connector accommodation portion 220. However, first side wall portion 223 and second side wall portion 224 only need to be provided in correspondence with the respective components of connector portion 120. For example, first side wall portion 223 and second side wall portion 224 may be provided on the second direction D2 side or the sixth direction D6 side of body accommodation portion 210. First side wall portion 223 may be provided on the third direction D3 side of body accommodation portion 210, and second side wall portion 224 may be provided on the fourth direction D4 side of body accommodation portion 210.

In the present embodiment, upper wall portion 225 connects the end edges of facing surface 222, first side wall portion 223, and second side wall portion 224 on the fifth direction D5 side. Upper wall portion 225 faces top surface 128 in the accommodation state. In the accommodation state, upper wall portion 225 may be separated from top surface 128.

As shown in FIG. 3, in the accommodation state, a first distance W1, which is the distance from the end edge of connection surface 122 in third direction D3 to first side wall portion 223, is larger than a second distance W2, which is the distance in third direction D3 from the third direction D3 side of power storage body portion 110 to body accommodation portion 210. In the accommodation state, a third distance W3, which is the distance from the end edge of connection surface 122 in fourth direction D4 to second side wall portion 224, is larger than a fourth distance W4, which is the distance in fourth direction D4 from the fourth direction D4 side of power storage body portion 110 to body accommodation portion 210. In the present embodiment, the third direction D3 side of power storage body portion 110 is third surface 113. The fourth direction D4 side of power storage body portion 110 is fourth surface 114.

Further, the relationship between the dimensions and distances in the present embodiment will be described. As shown in FIGS. 3 and 6, a dimension (Wfro) of connection surface 122 in third direction D3 is smaller than a distance (Wsid) in third direction D3 between first side wall portion 223 and second side wall portion 224. A dimension (L1) in second direction D2 from the tip of first terminal 121 in second direction D2 to the end edge of first side surface 125 in second direction D2 is smaller than a dimension (L5) in first direction D1 from the tip of second terminal 221 in first direction D1 to the top edge of first side wall portion 223 in first direction D1. A dimension (L3) in second direction D2 from the tip of first terminal 121 in second direction D2 to the top edge of second side surface 126 in second direction D2 is smaller than a dimension (L6) in first direction D1 from the tip of second terminal 221 in first direction D1 to the top edge of second side wall portion 224 in first direction D1. A dimension (Wwid) in third direction D3 between first side surface 125 and second side surface 126 is substantially equal to the distance (Wsid) in third direction D3 between first side wall portion 223 and second side wall portion 224. First side surface 125 and second side surface 126 extend parallel to first direction D1. The inner surface of first side wall portion 223 and the inner surface of second side wall portion 224 extend parallel to first direction D1. First terminal 121 and/or second terminal 221 extends parallel to first direction D1.

With the configuration described above, even when power storage body portion 110 is misaligned with body accommodation portion 210 in third direction D3 or fourth direction D4 during insertion of power storage body portion 110 into body accommodation portion 210 through opening 211, connector portion 120 can easily enter between first side wall portion 223 and second side wall portion 224 because the dimension (Wfro) described above is smaller than the distance (Wsid) described above. When power storage device 100 is pushed further in second direction D2 after the entrance of connector portion 120 with the above misalignment, connector portion 120 is displaced such that first inclined surface 123 slides on the top edge of first side wall portion 223. Alternatively, connector portion 120 is displaced such that second inclined surface 124 slides on the top edge of second side wall portion 224. As a result, connector portion 120 is aligned with connector accommodation portion 220 in third direction D3 and fourth direction D4. Since the dimension (L1) described above is smaller than the dimension (L5) described above and the dimension (L3) described above is smaller than the dimension (L6) described above, this alignment is complete before first terminal 121 and second terminal 221 come into contact with each other. Further, since the dimension (Wwid) described above is substantially equal to the distance (Wsid) described above and first side surface 125 and second side surface 126 extend parallel to first direction D1, and the inner surface of first side wall portion 223 and the inner surface of second side wall portion 224 extend parallel to first direction D1, connector portion 120 can be displaced while remaining aligned. In addition, since first terminal 121 and/or second terminal 221 extends parallel to first direction D1, first terminal 121 and second terminal 221 are fitted with each other by pushing power storage device 100 further in second direction D2. This can suppress damage to first terminal 121 and second terminal 221 due to contact between these terminals that are insufficiently aligned.

In addition, first side wall portion 223 and second side wall portion 224 are provided so as not to face connection surface 122 in first direction D1 during accommodation of power storage device 100 in housing portion 200 through opening 211.

The configuration described above can more reliably bring first inclined surface 123 into contact with the top edge of first side wall portion 223 or bring second inclined surface 124 into contact with the top edge of second side wall portion 224.

Further, as described above, the top edge of first side wall portion 223 in first direction D1 is contiguous to opening 211, and the top edge of second side wall portion 224 in first direction D1 is contiguous to opening 211.

The configuration described above allows the space between first side wall portion 223 and second side wall portion 224, which is the accommodation space of connector accommodation portion 220, to be visually recognized easily from the first direction side. Thus, first terminal 121 of connector portion 120 can be more reliably fitted with second terminal 221 of connector accommodation portion 220.

Description will be given below of various modifications of the power supply apparatus according to Embodiment 1 of the present disclosure. In the descriptions of the various modifications, the same components and effects as those of Embodiment 1 may not be repeated. In the descriptions of the various modifications, the same components and effects as those of Embodiment 1 may be described.

### Modification 1 of Embodiment 1

The first terminal may have a configuration different from the configuration described above. FIG. 9 is a partial plan view of a power supply apparatus according to Modification 1 of Embodiment 1. As shown in FIG. 9, in Modification 1 of Embodiment 1, first terminal 121 has a pair of receiving wall portions 121a. The pair of receiving wall portions 121a face each other in third direction D3. The pair of receiving wall portions 121a extend from connection surface 122 toward first direction D1. The pair of receiving wall portions 121a extend so as to have a smaller distance in third direction D3 toward first direction D1.

With the configuration described above, during accommodation of power storage device 100 in housing portion 200, second terminals 221 can be easily fitted into first terminals 121 as second terminals 221 come into contact with the pair of receiving wall portions 121a.

### Modification 2 of Embodiment 1

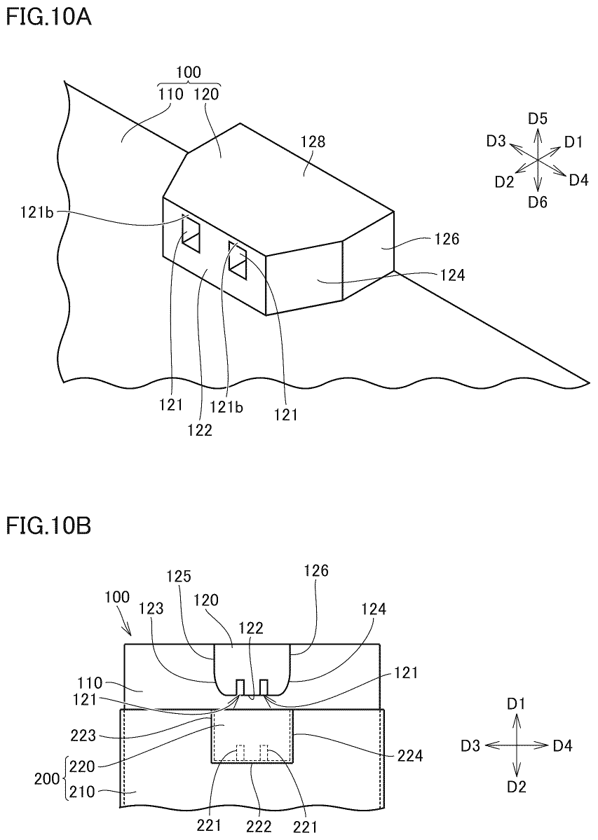

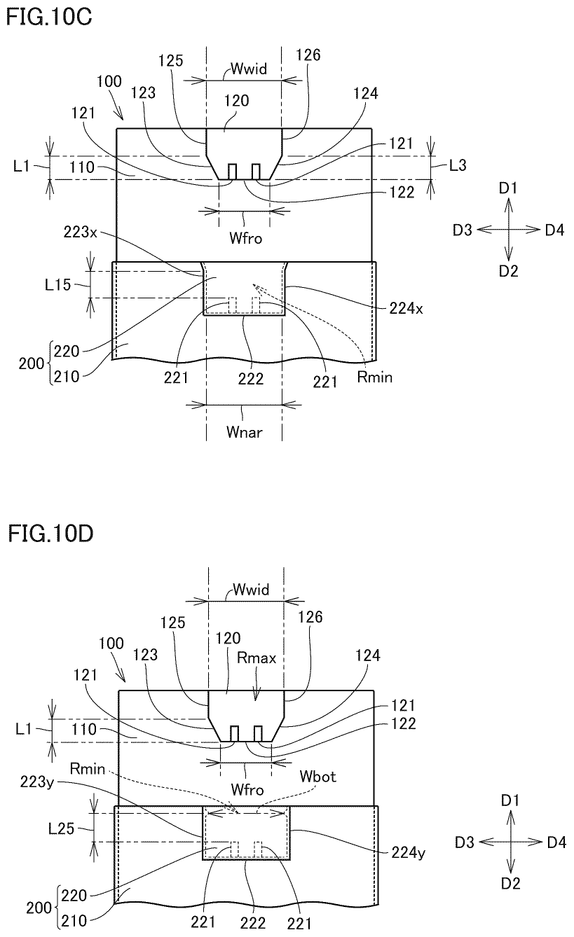

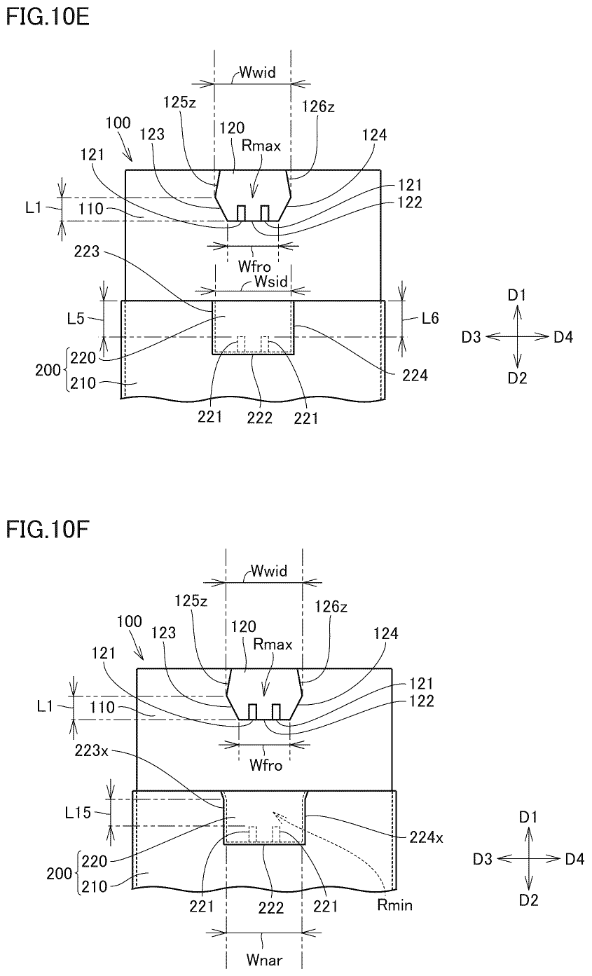

FIG. 10A is a partial perspective view of a power supply apparatus according to Modification 2 of Embodiment 1. As shown in FIG. 10A, in Modification 2 of Embodiment 1, first terminal 121 may further have a cover portion 121b that covers its upper portion. This can suppress the entry of foreign matter such as dust into first terminal 121.

### Modification 3 of Embodiment 1

FIG. 10B is a partial plan view of a power supply apparatus according to Modification 3 of Embodiment 1. As shown in FIG. 10B, in Modification 3 of Embodiment 1, as viewed from the fifth direction D5 side, first inclined surface 123 may extend to be curved in a projecting manner toward second direction D2 and third direction D3. As viewed from fifth direction D5, second inclined surface 124 may extend to be curved outwardly in a projecting manner.

### Modification 4 of Embodiment 1

The connector accommodation portion may have a configuration different from the configuration described above. FIG. 10C is a partial plan view of a power supply apparatus according to Modification 4 of Embodiment 1. As shown in FIG. 10C, connector accommodation portion 220 further has a minimum width region Rmin, in which the distance in third direction D3 between a first side wall portion 223x and a second side wall portion 224x is the smallest. In the present modification, on the first direction D1 side relative to minimum width region Rmin, the distance between first side wall portion 223x and second side wall portion 224x increases toward first direction D1.

In the present modification, the dimension (Wfro) of connection surface 122 in third direction D3 is smaller than a distance (Wnar) between first side wall portion 223x and second side wall portion 224x in minimum width region Rmin. The dimension (L1) in second direction D2 from the tip of first terminal 121 in second direction D2 to the end edge of first side surface 125 in second direction D2 and the dimension (L3) in second direction D2 from the tip of first terminal 121 in second direction D2 to the top edge of second side surface 126 in second direction D2 are smaller than a dimension (L15) in first direction D1 from the tip of second terminal 221 in first direction D1 to the top edge of minimum width region Rmin in first direction D1. A dimension (Wwid) in third direction D3 between first side surface 125 and second side surface 126 is substantially equal to the distance (Wnar) between first side wall portion 223x and second side wall portion 224x in minimum width region Rmin. First side surface 125 and second side surface 126 extend parallel to first direction D1. In minimum width region Rmin, the inner surface of first side wall portion 223x and the inner surface of second side wall portion 224x extend parallel to first direction D1.

With the configuration described above, even when power storage body portion 110 is misaligned with body accommodation portion 210 in third direction D3 or fourth direction D4 during insertion of power storage body portion 110 into body accommodation portion 210 through opening 211, connector portion 120 can easily enter between first side wall portion 223x and second side wall portion 224x because the dimension (Wfro) described above is smaller than the distance (Wnar) described above. When power storage device 100 is pushed further in second direction D2 after the entrance of connector portion 120 with the above misalignment, connector portion 120 is displaced such that first inclined surface 123 slides on the top edge of first side wall portion 223x in first direction D1 in minimum width region Rmin. Alternatively, connector portion 120 is displaced such that second inclined surface 124 slides on the top edge of second side wall portion 224x in first direction D1 in minimum width region Rmin. As a result, connector portion 120 is aligned with connector accommodation portion 220 in third direction D3 and fourth direction D4. Since the dimension (L1) described above and the dimension (L3) described above are smaller than the dimension (L15) described above, this alignment is complete before first terminal 121 and second terminal 221 come into contact with each other. Further, since the dimension (Wwid) described above is substantially equal to the distance (Wnar) described above, first side surface 125 and second side surface 126 extend parallel to first direction D1, and the inner surface of first side wall portion 223x and the inner wall of second side wall portion 224x extend parallel to first direction D1 in minimum width region Rmin, connector portion 120 can be displaced while remaining aligned. In addition, since first terminal 121 and/or second terminal 221 extends parallel to first direction D1, first terminal 121 and second terminal 221 are fitted with each other by pushing power storage device 100 further in second direction D2. This can suppress damage to first terminal 121 and second terminal 221 due to contact between these terminals that are insufficiently aligned.

### Modification 5 of Embodiment 1

FIG. 10D is a partial plan view of a power supply apparatus according to Modification 5 of Embodiment 1. As shown in FIG. 10D, connector portion 120 further has a maximum width region Rmax, in which the dimension of connector portion 120 in third direction D3 is the largest. In the present modification, maximum width region Rmax is the region between first side surface 125 and second side surface 126.

Connector accommodation portion 220 further has minimum width region Rmin, in which the distance in third direction D3 between a first side wall portion 223y and a second side wall portion 224y is the smallest. In minimum width region Rmin, a projection is provided on each of the inner surface of first side wall portion 223y and the inner surface of second side wall portion 224y.

In the present modification, the dimension (Wfro) of connection surface 122 in third direction D3 is smaller than a distance (Wbot) between first side wall portion 223y and second side wall portion 224y in minimum width region Rmin. The dimension (L1) in second direction D2 from the tip of first terminal 121 in second direction D2 to the top edge of maximum width region Rmax in second direction D2 is smaller than a dimension (L25) in first direction D1 from the tip of second terminal 221 in first direction D1 to minimum width region Rmin. The dimension (Wwid) of connector portion 120 in third direction D3 in maximum width region Rmax is substantially equal to the distance (Wbot) between first side wall portion 223y and second side wall portion 224y in minimum width region Rmin. First side surface 125 and second side surface 126 extend parallel to first direction D1.

With the configuration described above, even when power storage body portion 110 is misaligned with body accommodation portion 210 in third direction D3 or fourth direction D4 during insertion of power storage body portion 110 into body accommodation portion 210 through opening 211, connector portion 120 can easily enter between first side wall portion 223y and second side wall portion 224y because the dimension (Wfro) described above is smaller than the distance (Wbot) described above. When power storage device 100 is pushed further in second direction D2 after the entrance of connector portion 120 with the above misalignment, connector portion 120 is displaced such that first inclined surface 123 slides on first side wall portion 223y in minimum width region Rmin. Alternatively, connector portion 120 is displaced such that second inclined surface 124 slides on the top edge of second side wall portion 224y in minimum width region Rmin. As a result, connector portion 120 is aligned with connector accommodation portion 220 in third direction D3 and fourth direction D4. Since the dimension (L1) described above is smaller than the dimension (L25) described above, this alignment is complete before first terminal 121 and second terminal 221 come into contact with each other. Further, since the dimension (Wwid) described above is substantially equal to the distance (Wbot) described above and first side surface 125 and second side surface 126 extend parallel to first direction D1, connector portion 120 can be displaced while remaining aligned. Since first terminal 121 and/or second terminal 221 extends parallel to first direction D1, first terminal 121 and second terminal 221 are fitted with each other by pushing power storage device 100 further in second direction D2. This can suppress damage to first terminal 121 and second terminal 221 due to contact between these terminals that are insufficiently aligned.

### Modification 6 of Embodiment 1

FIG. 10E is a partial plan view of a power supply apparatus according to Modification 6 of Embodiment 1. As shown in FIG. 10E, connector portion 120 further has maximum width region Rmax, in which the dimension of connector portion 120 in third direction D3 is the largest. In the present modification, maximum width region Rmax is the region between the end edge of a first side surface 125z in second direction D2 and the end edge of a second side surface 126z in second direction D2. The dimension in third direction D3 between first side surface 125z and second side surface 126z decreases toward first direction D1.

In the present modification, the dimension (Wfro) of connection surface 122 in third direction D3 is smaller than the distance (Wsid) in third direction D3 between first side wall portion 223 and second side wall portion 224. The distance (L1) in first direction D1 from the tip of first terminal 121 in second direction D2 to maximum width region Rmax is smaller than the dimension (L5) in first direction D1 from the tip of second terminal 221 in first direction D1 to the top edge of first side wall portion 223 in first direction D1. The distance (L1) in first direction D1 from the tip of first terminal 121 in second direction D2 to maximum width region Rmax is smaller than the dimension (L6) in first direction D1 from the tip of second terminal 221 in first direction D1 to the top edge of second side wall portion 224 in first direction D1. The dimension (Wwid) of connector portion 120 in third direction D3 in maximum width region Rmax is substantially equal to the distance (Wsid) in third direction D3 between first side wall portion 223 and second side wall portion 224. The inner surface of first side wall portion 223 and the inner surface of second side wall portion 224 extend parallel to first direction D1.

With the configuration described above, even when power storage body portion 110 is misaligned with body accommodation portion 210 in third direction D3 or fourth direction D4 during insertion of power storage body portion 110 into body accommodation portion 210 through opening 211, connector portion 120 can easily enter between first side wall portion 223 and second side wall portion 224 because the dimension (Wfro) described above is smaller than the distance (Wsid) described above. When power storage device 100 is pushed further in second direction D2 after the entrance of connector portion 120 with the above misalignment, connector portion 120 is displaced such that first inclined surface 123 slides on the top edge of first side wall portion 223. Alternatively, connector portion 120 is displaced such that second inclined surface 124 slides on the top edge of second side wall portion 224. As a result, connector portion 120 is aligned with connector accommodation portion 220 in third direction D3 and fourth direction D4. Since the dimension (L1) described above is smaller than the dimension (L5) described above and the dimension (L1) described above is smaller than the dimension (L6) described above, this alignment is complete before first terminal 121 and second terminal 221 come into contact with each other. Further, since the dimension (Wwid) described above is substantially equal to the distance (Wsid) described above and the inner surface of first side wall portion 223 and the inner surface of second side wall portion 224 extend parallel to first direction D1, connector portion 120 can be displaced while remaining aligned. In addition, since first terminal 121 and/or second terminal 221 extends parallel to first direction D1, first terminal 121 and second terminal 221 are fitted with each other by pushing power storage device 100 further in second direction D2. This can suppress damage to first terminal 121 and second terminal 221 due to contact between these terminals that are insufficiently aligned.

### Modification 7 of Embodiment 1

FIG. 10F is a partial plan view of a power supply apparatus according to Modification 7 of Embodiment 1. As shown in FIG. 10F, connector portion 120 further has maximum width region Rmax, in which the dimension of connector portion 120 in third direction D3 is the largest. In the present modification, maximum width region Rmax is the region between the end edge of first side surface 125z in second direction D2 and the end edge of second side surface 126z in second direction D2. The dimension in third direction D3 between first side surface 125z and second side surface 126z decreases toward first direction D1.

Connector accommodation portion 220 further has minimum width region Rmin, in which the distance in third direction D3 between first side wall portion 223x and second side wall portion 224x is the smallest. In the present modification, on the first direction D1 side relative to minimum width region Rmin, the distance between first side wall portion 223x and second side wall portion 224x increases toward first direction D1.

In the present modification, the dimension (Wfro) of connection surface 122 in third direction D3 is smaller than the distance (Wnar) between first side wall portion 223x and second side wall portion 224x in minimum width region Rmin. The distance (L1) in first direction D1 from the tip of first terminal 121 in second direction D2 to maximum width region Rmax is smaller than the dimension (L15) in first direction D1 from the tip of second terminal 221 in first direction D1 to the top edge of minimum width region Rmin in first direction D1. The dimension (Wwid) of connector portion 120 in third direction D3 in maximum width region Rmax is substantially equal to the distance (Wnar) between first side wall portion 223x and second side wall portion 224x in minimum width region Rmin. In minimum width region Rmin, the inner surface of first side wall portion 223x and the inner surface of second side wall portion 224x extend parallel to first direction D1.

According to the configuration described above, even when power storage body portion 110 is misaligned with body accommodation portion 210 in third direction D3 or fourth direction D4 during insertion of power storage body portion 110 into body accommodation portion 210 through opening 211, connector portion 120 can easily enter between first side wall portion 223x and second side wall portion 224x because the dimension (Wfro) described above is smaller than the distance (Wnar) described above. When power storage device 100 is pushed further in second direction D2 after the entrance of connector portion 120 with the above misalignment, connector portion 120 is displaced such that first inclined surface 123 slides on the top edge of first side wall portion 223x in first direction D1 in minimum width region Rmin. Alternatively, connector portion 120 is displaced such that second inclined surface 124 slides on the top edge of second side wall portion 224x in first direction D1 in minimum width region Rmin. As a result, connector portion 120 is aligned with connector accommodation portion 220 in third direction D3 and fourth direction D4. Since the dimension (L1) described above is smaller than the dimension (L15) described above, this alignment is complete before first terminal 121 and second terminal 221 come into contact with each other. Further, since the dimension (Wwid) described above is substantially equal to the distance (Wnar) described above and the inner surface of first side wall portion 223x and the inner surface of second side wall portion 224x extend parallel to first direction D1, connector portion 120 can be displaced while remaining aligned. In addition, since first terminal 121 and/or second terminal 221 extends parallel to first direction D1, first terminal 121 and second terminal 221 are fitted with each other by pushing power storage device 100 further in second direction D2. This can suppress damage to first terminal 121 and second terminal 221 due to contact between these terminals that are insufficiently aligned.

### Embodiment 2

Next, a power supply apparatus according to Embodiment 2 of the present disclosure will be described. The power supply apparatus according to Embodiment 2 of the present disclosure differs from that of Embodiment 1 mainly in that the power storage device further includes a lever, which will be described later. Thus, the same components and effects as those of Embodiment 1 will not be repeatedly described.

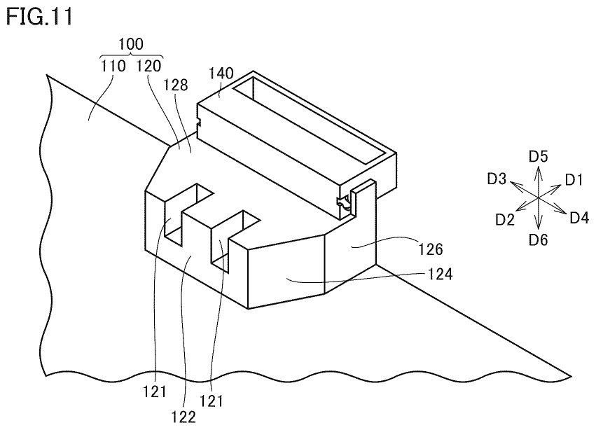

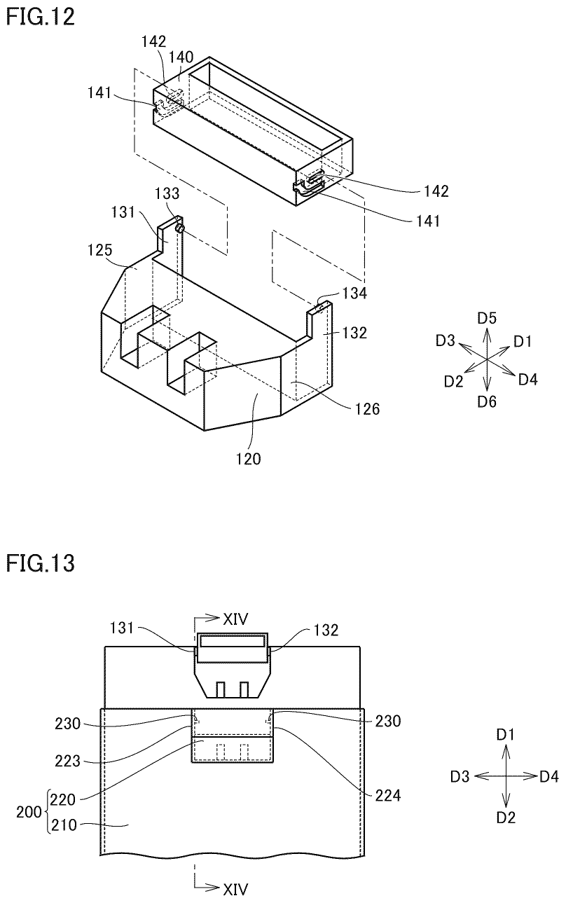

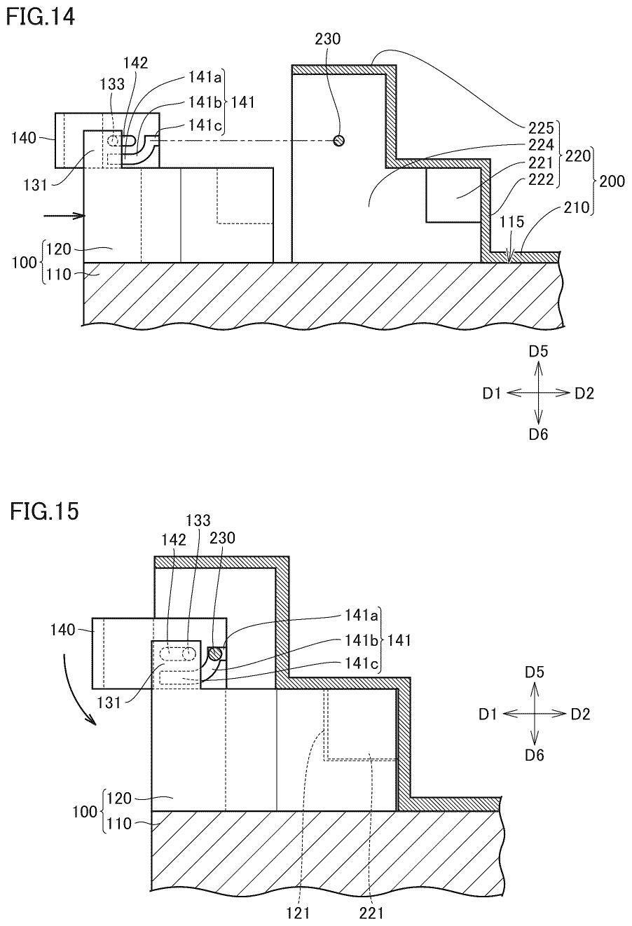

FIG. 11 is a partial perspective view of the power storage device according to Embodiment 2. FIG. 12 is an exploded perspective view of the power storage device according to Embodiment 2 with a lever disassembled. FIG. 13 is a plan view showing the state of the power storage device being attached to or detached from a housing portion in Embodiment 2. FIG. 14 is a partial sectional view showing the state of FIG. 13, as viewed from the direction of the arrow XIV-XIV.

As shown in FIGS. 11 to 14, power storage device 100 further includes a lever 140. Lever 140 is pivotably supported by power storage body portion 110 or connector portion 120. In the present embodiment, lever 140 is pivotably supported by connector portion 120.

Power storage body portion 110 or connector portion 120 further has a first sliding contact surface portion 131, a second sliding contact surface portion 132, a first shaft portion 133, and a second shaft portion 134 for pivotably supporting lever 140. In the present embodiment, connector portion 120 further has first sliding contact surface portion 131, second sliding contact surface portion 132, first shaft portion 133, and second shaft portion 134.

First sliding contact surface portion 131 and second sliding contact surface portion 132 sandwich lever 140 in between such that lever 140 can pivot. First sliding contact surface portion 131 and second sliding contact surface portion 132 project in first direction D1 from power storage body portion 110 or connector portion 120, and specifically, project in first direction D1 from connector portion 120. First sliding contact surface portion 131 and second sliding contact surface portion 132 are aligned with each other in third direction D3.

First shaft portion 133 projects from first sliding contact surface portion 131 toward second sliding contact surface portion 132. First shaft portion 133 has a pin-like outer shape. First shaft portion 133 pivotably supports connector portion 120. Second shaft portion 134 has a pin-like outer shape. Second shaft portion 134 also pivotably supports connector portion 120. First shaft portion 133 and second shaft portion 134 are aligned in the third direction.

Lever 140 has a pair of guide rails 141 and a pair of bearing portions 142. The pair of bearing portions 142 will be described first, and the details of the pair of guide rails 141 will be described later.

The pair of bearing portions 142 are provided on the third direction D3 side and the fourth direction D4 side of lever 140. In the present embodiment, the pair of bearing portions 142 can have the same configuration. In addition, in the present embodiment, the pair of bearing portions 142 can have a similar configuration in correspondence with first shaft portion 133 and second shaft portion 134, respectively. For this reason, only first shaft portion 133 and its corresponding bearing portion 142 may be described below.

One of the pair of bearing portions 142 pivotably supports first shaft portion 133. This bearing portion 142 slidably supports first shaft portion 133 in one direction. The other bearing portion 142 pivotably supports second shaft portion 134. The other bearing portion 142 also slidably supports second shaft portion 134 in one direction.

Housing portion 200 further has a pair of guide pins 230. Guide pins 230 project in a direction orthogonal to second direction D2 from body accommodation portion 210 or connector accommodation portion 220. In the present embodiment, guide pins 230 project from connector accommodation portion 220. One guide pin 230 of the pair of guide pins 230 projects from first side wall portion 223 in fourth direction D4. The other guide pin 230 of the pair of guide pins 230 projects from second side wall portion 224 in third direction D3. The pair of guide pins 230 are aligned with each other in third direction D3.

Next, the pair of guide rails 141 will be described. The pair of guide rails 141 are provided on the third direction D3 side and the fourth direction D4 side of lever 140. In the present embodiment, the pair of guide rails 141 can have the same configuration. Specifically, in the present embodiment, the pair of guide rails 141 can have the same configuration in correspondence with the pair of guide pins 230, respectively. For this reason, only one of guide rails 141 and a corresponding one of guide pins 230 may be described below.

Guide rail 141 has an inlet groove 141a, a curved groove 141b, and an extension groove 141c (see FIG. 14).

FIG. 15 is a partial sectional view of a power supply apparatus when the lever is in a first state in Embodiment 2. In FIG. 15, a sectional view corresponding to FIG. 14 is shown. As shown in FIGS. 14 and 15, inlet groove 141a extends in second direction D2 when lever 140 is in the first state. When lever 140 is in the first state, inlet groove 141a allows guide pin 230 to enter inlet groove 141a during housing of power storage device 100 in housing portion 200. In the first state, bearing portion 142 also extends along second direction D2.

Curved groove 141b extends from inlet groove 141a in the pivot direction of lever 140. More specifically, in the first state and when guide pin 230 is located on the first direction D1 side of inlet groove 141a, curved groove 141b extends in an approximately circumferential direction about guide pin 230, as viewed from the third direction D3 side or the fourth direction D4 side.

Extension groove 141c extends further in first direction D1 from the end of curved groove 141b opposite to the inlet groove 141a side in the first state.

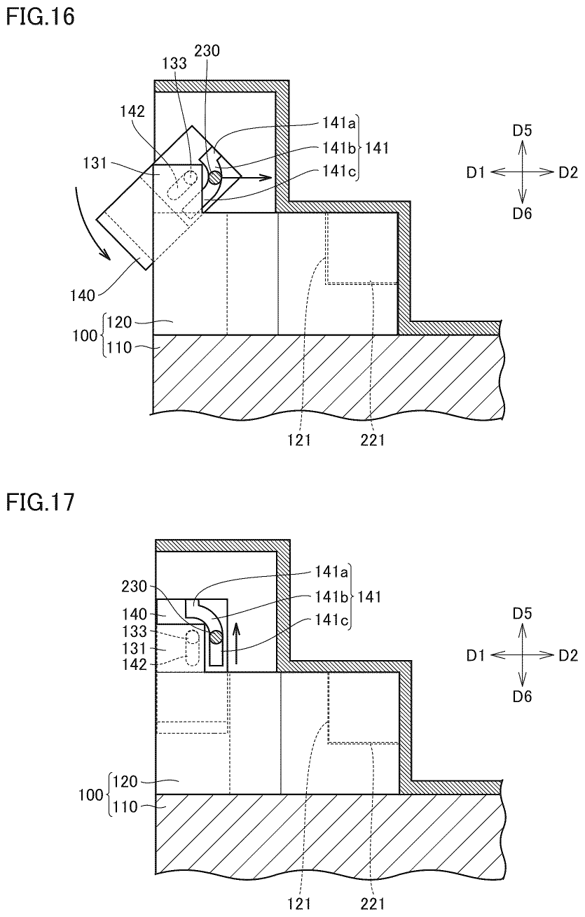

FIG. 16 is a partial sectional view showing the state of the lever changing from the first state in FIG. 15 to the second state. FIG. 17 is a partial sectional view of a power supply apparatus when the lever is in the second state in Embodiment 2. In FIGS. 16 and 17, the sectional views corresponding to FIGS. 14 and 15 are shown.

As shown in FIGS. 15 to 17, lever 140 is configured to pivot from the first state to the second state to urge curved groove 141b in second direction D2 while further moving guide pine 230, which has entered inlet groove 141a, through curved groove 141b relative to guide rail 141.

With the above configuration, when the worker causes lever 140 to pivot, curved groove 141b is urged in second direction D2, and in turn, power storage device 100 is urged in second direction D2. This allows the worker to accommodate power storage device 100 in housing portion 200 with a relatively small force.

In the present embodiment, lever 140 pivots about first shaft portion 133 and second shaft portion 134 from the first state to the second state.

In the present embodiment, the first state is a state in the middle of insertion of second terminal 221 into first terminal 121. However, the first state may be a state before second terminal 221 is inserted into first terminal 121. In the present embodiment, the second state is a state in which the insertion of second terminal 221 into first terminal 121 is complete. However, the second state may be a state in the middle of insertion of second terminal 221 into first terminal 121.

In the second state, extension groove 141c extends in a direction intersecting second direction D2 from the end of curved groove 141b opposite to inlet groove 141a. In the second state, bearing portion 142 extends in sixth direction D6 as viewed from first shaft portion 133.

FIG. 18 is a partial sectional view of the power supply apparatus when the lever is in a third state in Embodiment 2. In FIG. 18, the sectional view corresponding to FIGS. 14 to 17 is shown.

As shown in FIGS. 17 and 18, lever 140 is configured to slide from curved groove 141b in the direction opposite to the direction of extension of extension groove 141c from the second state to allow guide pin 230 to enter extension groove 141c from curved groove 141b relative to guide rail 141. This brings lever 140 into the third state.

With the configuration described above, in the third state, guide pin 230 is fixed in first direction D1 by extension groove 141c. This can suppress unintentional detachment of the accommodated power storage device 100 from housing portion 200.

In the present embodiment, when the second state changes to the third state, first shaft portion 133 also moves within bearing portion 142 relative to guide rail 141.

### Embodiment 3

Next, a power supply apparatus according to Embodiment 3 of the present disclosure will be described. The power supply apparatus according to Embodiment 3 of the present disclosure differs from that of Embodiment 2 mainly in the lever configuration. Thus, the same components and effects as those of Embodiment 2 will not be repeatedly described.

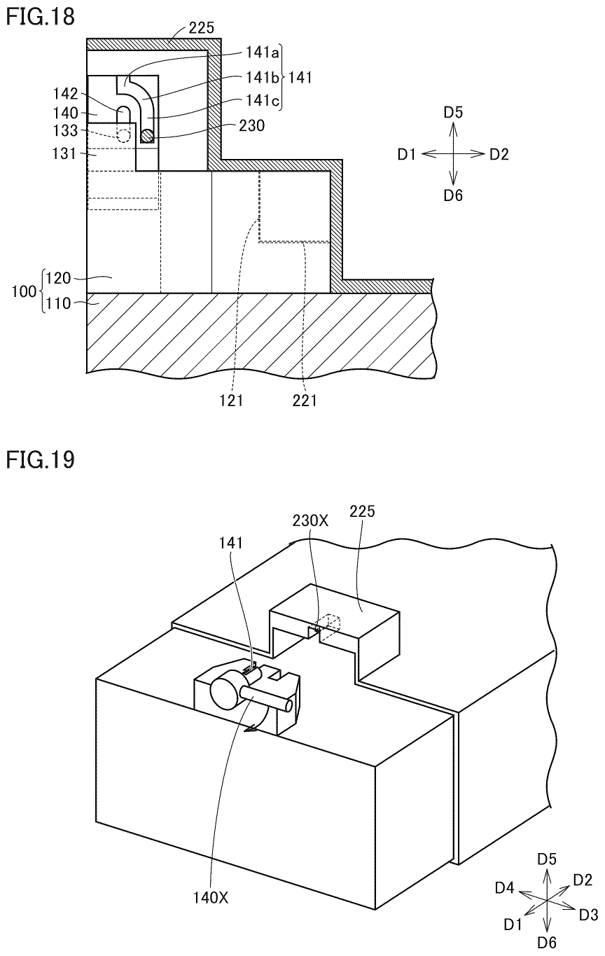

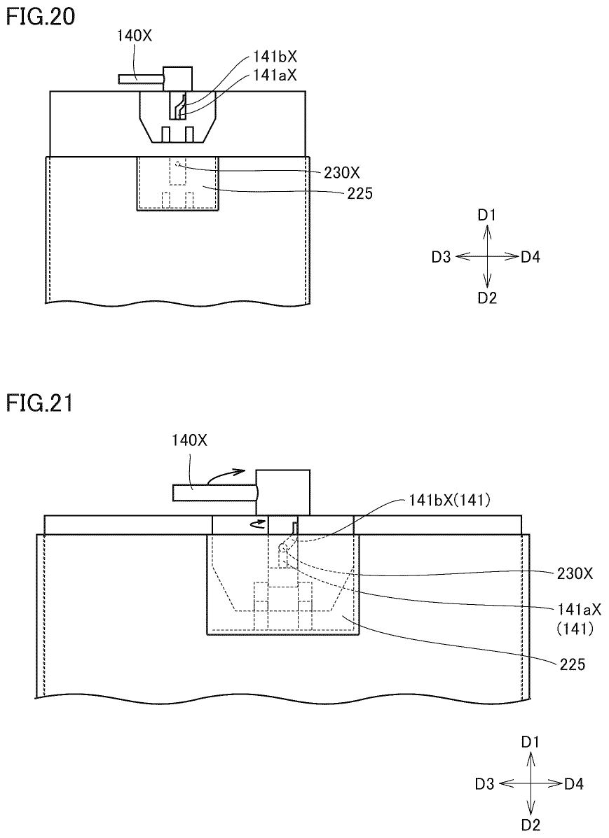

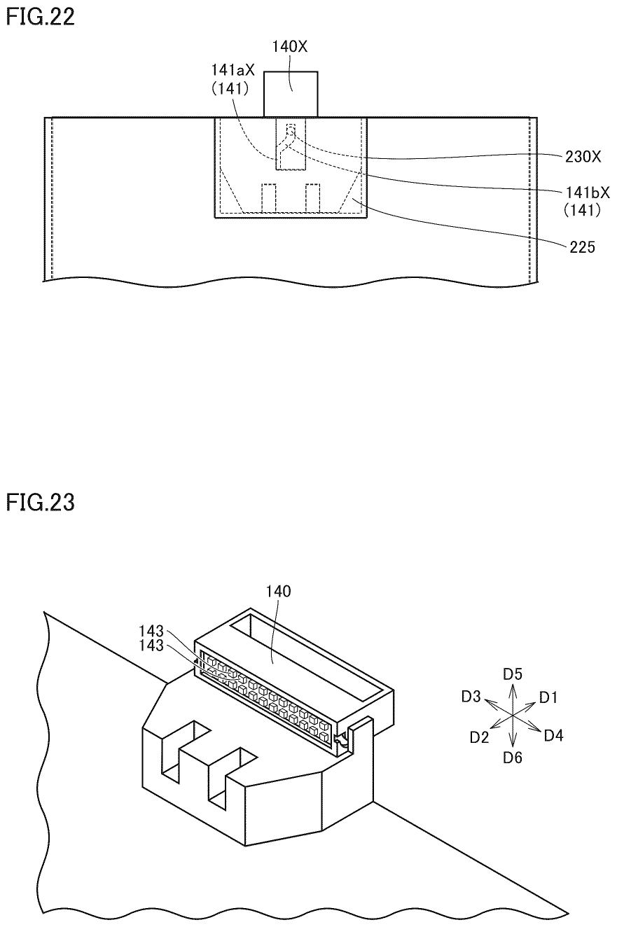

FIG. 19 is a perspective view showing the state of the power storage device being attached to or detached from a housing portion in Embodiment 3. FIG. 20 is a partial plan view showing the state of the power storage device being attached to or detached from the housing portion in Embodiment 3. FIG. 21 is a partial plan view of the power supply apparatus when the lever is in the first state in Embodiment 3. FIG. 22 is a partial plan view of the power supply apparatus when the lever is in the second state in Embodiment 3.

As shown in FIGS. 19 to 22, also in Embodiment 3, a lever 140X is configured to pivot from the first state to the second state to urge a curved groove 141bX in second direction D2 while further moving a guide pin 230X, which has entered an inlet groove 141aX, through curved groove 141bX relative to guide rail 141.

In the present embodiment, lever 140X is configured to be pivotable about a central axis line extending along first direction D1. Curved groove 141bX extends toward first direction D1 while extending from inlet groove 141a along the pivot direction of the lever. In addition, guide pin 230X projects from upper wall portion 225 in sixth direction D6.

### Embodiment 4

Next, a power supply apparatus according to Embodiment 4 of the present disclosure will be described. The power supply apparatus according to Embodiment 4 of the present disclosure differs from that of Embodiment 2 mainly in that the lever has a third terminal. Thus, the same components and effects as those of Embodiment 2 will not be repeatedly described.

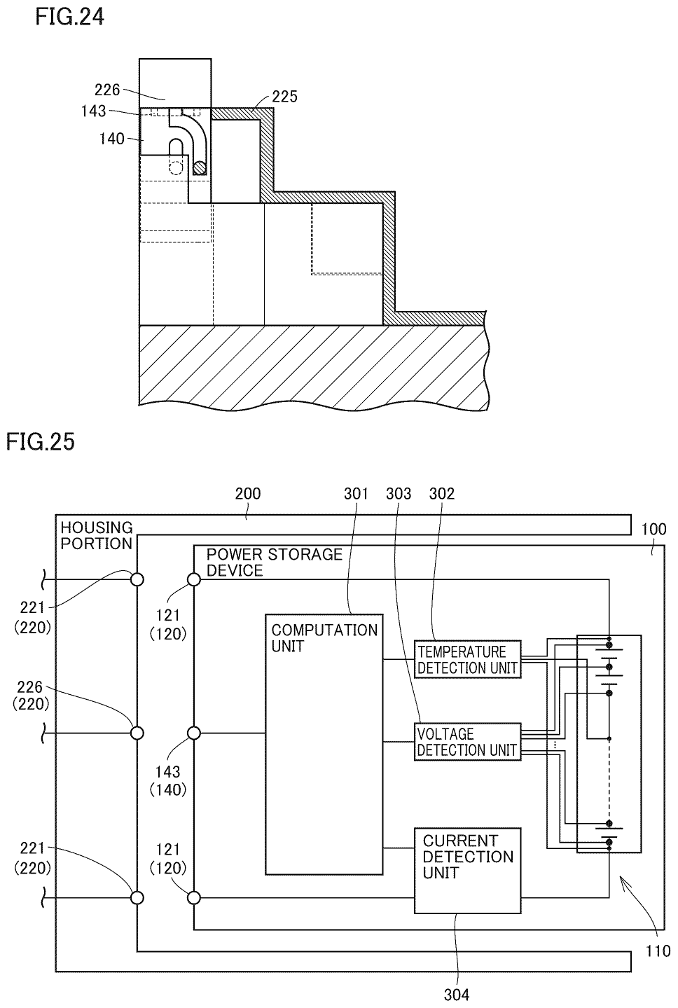

FIG. 23 is a perspective view of a connector portion and its vicinity of a power storage device according to Embodiment 4. FIG. 24 is a partial sectional view of the power supply apparatus when the lever is in the third state in Embodiment 4. In FIG. 24, the sectional view corresponding to FIG. 18 in Embodiment 2 is shown.

As shown in FIGS. 23 and 24, lever 140 further has one or more third terminals 143. Connector accommodation portion 220 further has one or more fourth terminals 226. The third terminal and the fourth terminal are configured to be electrically connected to each other when lever 140 is in the third state.

In the present embodiment, third terminal 143 is provided so as to be located on the second direction D2 side of lever 140 when lever 140 is in the first state (see FIG. 23). Third terminal 143 is provided so as to be located on the fifth direction D5 side when lever 140 is in the second state and the third state (see FIG. 24). Fourth terminal 226 is provided on upper wall portion 225.

Examples of the functions of third terminal 143 and fourth terminal 226 will now be described. FIG. 25 is a functional block diagram schematically showing an example circuit in the power supply apparatus according to Embodiment 4. As shown in FIG. 25, third terminal 143 is electrically connected to power storage body portion 110. Specifically, third terminal 143 is electrically connected to power storage body portion 110 via a computation unit 301 provided in power storage device 100, and a temperature detection unit 302, a voltage detection unit 303, and a current detection unit 304, which electrically connect computation unit 301 to the power storage module in power storage body portion 110. In addition, fourth terminal 226 is configured to be electrically connectable to electrically-powered vehicle 1 (see FIG. 1). Via third terminal 143 and fourth terminal 226, thus, electrically-powered vehicle 1 can acquire various information of power storage device 100.

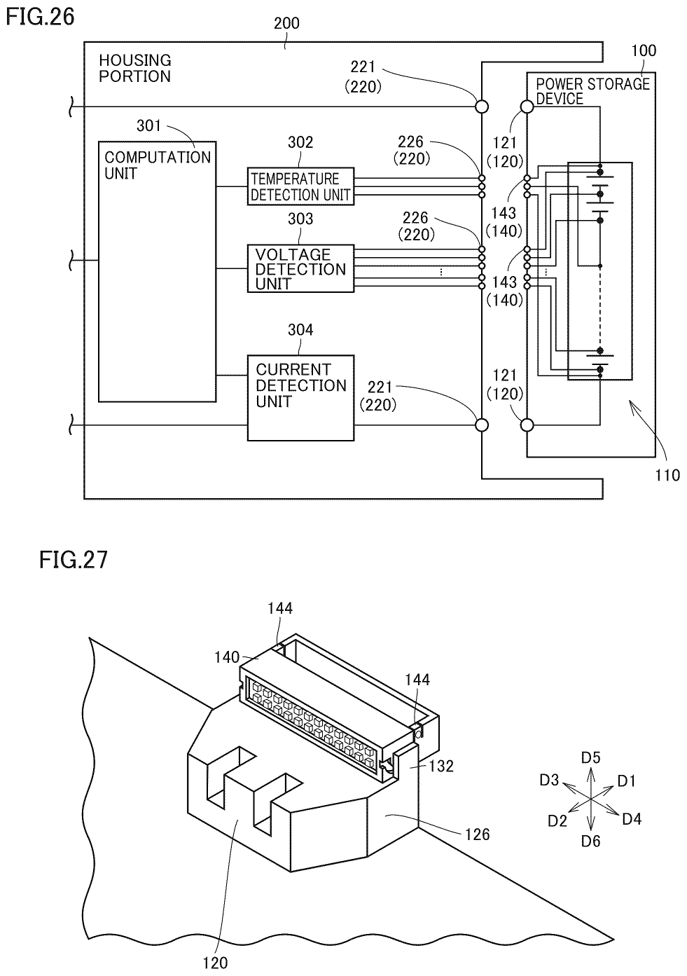

The example of the circuit in the power supply apparatus according to Embodiment 4 is not limited to the above. FIG. 26 is a functional block diagram showing another example of the circuit in the power supply apparatus according to Embodiment 4. As shown in FIG. 26, third terminal 143 may be directly electrically connected to the power storage module in power storage body portion 110. In this case, at least one of computation unit 301, temperature detection unit 302, voltage detection unit 303, and current detection unit 304 may be provided in housing portion 200 or in electrically-powered vehicle 1 (see FIG. 1).

### Embodiment 5

Finally, a power supply apparatus according to Embodiment 5 of the present disclosure will be described. The power supply apparatus according to Embodiment 5 of the present disclosure differs from the power supply apparatus according to Embodiment 4 mainly in the lever configuration. Thus, the same components and effect as those of Embodiment 4 will not be repeatedly described.

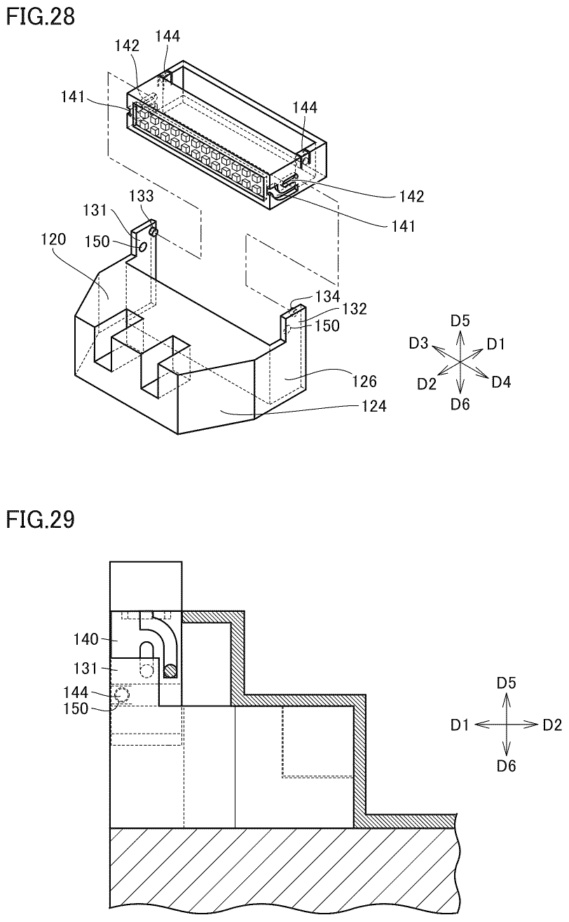

FIG. 27 is a partial perspective view of a power storage device according to Embodiment 5. FIG. 28 is an exploded perspective view of the power storage device according to Embodiment 5 with a lever disassembled. FIG. 29 is a partial sectional view of the power supply apparatus when the lever is in the third state in Embodiment 5. In FIG. 29, the sectional view corresponding to FIG. 24 in Embodiment 4 is shown.

As shown in FIGS. 27 to 29, lever 140 further has one or more engaging portions 144. Power storage device 100 further has one or more engagement portions 150. Specifically, one or more engagement portions 150 are provided in connector portion 120.

When lever 140 is in the third state, engaging portion 144 is configured to engage with its corresponding engagement portion 150. As a result, lever 140 is stably positioned in the third state. This can further suppress detachment of power storage device 100 accommodated in housing portion 200 from housing portion 200.

In the present embodiment, the pair of engaging portions 144 are provided respectively on the third direction D3 side and the fourth direction D4 side of lever 140. When lever 140 is in the first state and the second state, the pair of engaging portions 144 are provided at positions where they do not engage with their corresponding engagement portions 150.

In addition, the pair of engagement portions 150 are provided respectively in first sliding contact surface portion 131 and second sliding contact surface portion 132. During lever 140 changing from the first state to the second state, and during lever 140 changing from the second state to the third state, the pair of engaging portions 144 may be in sliding contact with first sliding contact surface portion 131 and second sliding contact surface portion 132, respectively.

In the description of the embodiments and the modifications thereof described above, the components that can be combined may be combined with each other.

Although the present embodiments of the present disclosure have been described, it should be understood that the present embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. A power supply apparatus comprising:
a power storage device; and
a housing portion mounted in an apparatus that uses the power storage device as a power supply, the housing portion detachably accommodating the power storage device, wherein
the power storage device includes
a power storage body portion, and
a connector portion provided outside the power storage body portion, the connector portion including a first terminal electrically connected to the power storage body portion,
the housing portion includes
a body accommodation portion having an opening that is open toward a first direction, the body accommodation portion detachably accommodating the power storage body portion through the opening, and
a connector accommodation portion having an accommodation space communicating with an accommodation space of the body accommodation portion, the connector accommodation portion accommodating the connector portion, the connector accommodation portion including a second terminal fittable with the first terminal of the accommodated connector portion,
the connector portion includes
a connection surface facing a second direction opposite to the first direction and being provided with the first terminal,
a first side surface facing a third direction intersecting the second direction and extending along a horizontal direction,
a second side surface facing a fourth direction opposite to the third direction,
a first inclined surface connecting the first side surface to the connection surface, and
a second inclined surface connecting the second side surface to the connection surface, and
the connector accommodation portion includes
a facing surface facing the connection surface in an accommodation state in which the power storage device is accommodated in the housing portion, the facing surface being provided with the second terminal,
a first side wall portion facing the first side surface in the accommodation state, and
a second side wall portion facing the second side surface in the accommodation state.

2. The power supply apparatus according to claim 1, wherein
a dimension (Wfro) of the connection surface in the third direction is smaller than a distance (Wsid) in the third direction between the first side wall portion and the second side wall portion,
a dimension (L1) in the second direction from a tip of the first terminal in the second direction to an end edge of the first side surface in the second direction is smaller than a dimension (L5) in the first direction from a tip of the second terminal in the first direction to a top edge of the first side wall portion in the first direction,
a dimension (L3) in the second direction from the tip of the first terminal in the second direction to a top edge of the second side surface in the second direction is smaller than a dimension (L6) in the first direction from the tip of the second terminal in the first direction to a top edge of the second side wall portion in the first direction,
a dimension (Wwid) in the third direction between the first side surface and the second side surface is substantially equal to the distance (Wsid) in the third direction between the first side wall portion and the second side wall portion,
the first side surface and the second side surface extend parallel to the first direction,
an inner surface of the first side wall portion and an inner surface of the second side wall portion extend parallel to the first direction, and
the first terminal and/or the second terminal extends parallel to the first direction.

3. The power supply apparatus according to claim 1, wherein
the connector accommodation portion further includes a minimum width region in which a distance in the third direction between the first side wall portion and the second side wall portion is the smallest,
a dimension (Wfro) of the connection surface in the third direction is smaller than a distance (Wnar) between the first side wall portion and the second side wall portion in the minimum width region,
a dimension (L1) in the second direction from a tip of the first terminal in the second direction to an end edge of the first side surface in the second direction and a dimension (L3) in the second direction from the tip of the first terminal in the second direction to a top edge of the second side surface in the second direction are smaller than a dimension (L15) in the first direction from a tip of the second terminal in the first direction to a top edge of the minimum width region in the first direction,
a dimension (Wwid) in the third direction between the first side surface and the second side surface is substantially equal to the distance (Wnar) between the first side wall portion and the second side wall portion in the minimum width region,
the first side surface and the second side surface extend parallel to the first direction,
in the minimum width region, an inner surface of the first side wall portion and an inner surface of the second side wall portion extend parallel to the first direction, and
the first terminal and/or the second terminal extends parallel to the first direction.

4. The power supply apparatus according to claim 1, wherein
the connector accommodation portion further includes a minimum width region in which a distance in the third direction between the first side wall portion and the second side wall portion is the smallest,
a dimension (Wfro) of the connection surface in the third direction is smaller than a distance (Wbot) between the first side wall portion and the second side wall portion in the minimum width region,
the connector portion further includes a maximum width region in which a dimension of the connector portion in the third direction is the largest,
a dimension (L1) in the second direction from a tip of the first terminal in the second direction to a top edge of the maximum width region in the second direction is smaller than a dimension (L25) in the first direction from a tip of the second terminal in the first direction to the minimum width region,
a dimension (Wwid) of the connector portion in the third direction in the maximum width region is substantially equal to the distance (Wbot) between the first side wall portion and the second side wall portion in the minimum width region,
the first side surface and the second side surface extend parallel to the first direction, and
the first terminal and/or the second terminal extends parallel to the first direction.

5. The power supply apparatus according to claim 1, wherein
a dimension (Wfro) of the connection surface in the third direction is smaller than a distance (Wsid) in the third direction between the first side wall portion and the second side wall portion,
the connector portion further includes a maximum width region in which a dimension of the connector portion in the third direction is the largest,
a distance (L1) in the first direction from a tip of the first terminal in the second direction to the maximum width region is smaller than a dimension (L5) in the first direction from a tip of the second terminal in the first direction to a top edge of the first side wall portion in the first direction,
the distance (L1) in the first direction from the tip of the first terminal in the second direction to the maximum width region is smaller than a dimension (L6) in the first direction from the tip of the second terminal in the first direction to a top edge of the second side wall portion in the first direction,
a dimension (Wwid) of the connector portion in the third direction in the maximum width region is substantially equal to the distance (Wsid) in the third direction between the first side wall portion and the second side wall portion,
an inner surface of the first side wall portion and an inner surface of the second side wall portion extend parallel to the first direction, and
the first terminal and/or the second terminal extends parallel to the first direction.

6. The power supply apparatus according to claim 1, wherein
the connector accommodation portion further includes a minimum width region in which a distance in the third direction between the first side wall portion and the second side wall portion is the smallest,
a dimension (Wfro) of the connection surface in the third direction is smaller than a distance (Wnar) between the first side wall portion and the second side wall portion in the minimum width region,
the connector portion further includes a maximum width region in which a dimension of the connector portion in the third direction is the largest,
a distance (L1) in the first direction from a tip of the first terminal in the second direction to the maximum width region is smaller than a dimension (L15) in the first direction from the tip of the second terminal in the first direction to a top edge of the minimum width region in the first direction,
a dimension (Wwid) of the connector portion in the third direction in the maximum width region is substantially equal to the distance (Wnar) between the first side wall portion and the second side wall portion in the minimum width region,
in the minimum width region, an inner surface of the first side wall portion and an inner surface of the second side wall portion extend parallel to the first direction, and
the first terminal and/or the second terminal extends parallel to the first direction.

7. The power supply apparatus according to claim 1, wherein the first side wall portion and the second side wall portion are provided so as not to face the connection surface in the first direction during accommodation of the power storage device in the housing portion through the opening.

8. The power supply apparatus according to claim 1, wherein
the top edge of the first side wall portion in the first direction is contiguous to the opening, and
the top edge of the second side wall portion in the first direction is contiguous to the opening.

9. The power supply apparatus according to claim 1, wherein
the second terminal projects toward the first direction,
the first terminal is recessed from the connection surface toward the first direction, and is configured to be fittable with the second terminal corresponding thereto,
the first terminal includes a pair of receiving wall portions, and
the pair of receiving wall portions face each other in the third direction, extend from the connection surface toward the first direction, and extend so as to have a smaller distance in the third direction toward the first direction.

10. The power supply apparatus according to claim 1, wherein
the power storage device further includes a lever pivotably supported by the power storage body portion or the connector portion,
the lever includes a guide rail,
the housing portion further includes a guide pin projecting from the body accommodation portion or the connector accommodation portion in a direction orthogonal to the second direction,
the guide rail includes
an inlet groove extending in the second direction when the lever is in a first state, the inlet groove allowing the guide pin to enter the inlet groove during housing of the power storage device in the housing portion, and
a curved groove extending from the inlet groove in a pivot direction of the lever, and
the lever is configured to pivot from the first state to a second state to urge the curved groove in the second direction while further moving, relative to the guide rail, the guide pin that has entered the inlet groove through the curved groove.

11. The power supply apparatus according to claim 10, wherein
the guide rail further includes an extension groove extending, in the second state, from an end of the curved groove opposite to an inlet groove side in a direction intersecting the second direction, and
the lever is configured to slide from the second state in a direction opposite to a direction of extension of the extension groove from the curved groove to cause the guide pin to enter the extension groove from the curved groove relative to the guide rail.

12. An electrically-powered vehicle comprising the power supply apparatus according to claim 1.

13. A power storage device to be accommodated in a housing portion that is open toward a first direction, the power storage device being accommodated in the housing portion to be electrically connectable to a terminal provided in the housing portion, the power storage device comprising:
a power storage body portion; and
a connector portion provided outside the power storage body portion, electrically connected to the power storage body portion, and including a first terminal fittable with the terminal provided in the housing portion,
wherein the connector portion includes
a connection surface facing a second direction opposite to the first direction and being provided with the first terminal,
a first inclined surface extending, from an end edge of the connection surface in a third direction intersecting the second direction and extending along a horizontal direction, so as to be inclined in the third direction toward the first direction,
a second inclined surface extending, from an end edge of the connection surface in a fourth direction opposite to the third direction, so as to be inclined in the fourth direction toward the first direction,
a first side surface extending along the first direction from an end edge of the first inclined surface in the first direction, and
a second side surface extending along the first direction from an end edge of the second inclined surface in the first direction.

14. The power storage device according to claim 13, wherein
a dimension in the second direction from the end edge of the first inclined surface in the first direction to a tip of the first terminal in the second direction is smaller than a dimension in the first direction from a tip of the first terminal in the first direction to a top edge of the first side surface in the first direction, and
a dimension in the second direction from the end edge of the second inclined surface in the first direction to the tip of the first terminal in the second direction is smaller than a dimension in the first direction from the tip of the first terminal in the first direction to a top edge of the second side surface in the first direction.

15. The power supply apparatus according to claim 2, wherein the first side wall portion and the second side wall portion are provided so as not to face the connection surface in the first direction during accommodation of the power storage device in the housing portion through the opening.

16. The power supply apparatus according to claim 2, wherein
the top edge of the first side wall portion in the first direction is contiguous to the opening, and
the top edge of the second side wall portion in the first direction is contiguous to the opening.

17. The power supply apparatus according to claim 2, wherein
the second terminal projects toward the first direction,
the first terminal is recessed from the connection surface toward the first direction, and is configured to be fittable with the second terminal corresponding thereto,
the first terminal includes a pair of receiving wall portions, and
the pair of receiving wall portions face each other in the third direction, extend from the connection surface toward the first direction, and extend so as to have a smaller distance in the third direction toward the first direction.

18. The power supply apparatus according to claim 2, wherein
the power storage device further includes a lever pivotably supported by the power storage body portion or the connector portion,
the lever includes a guide rail,
the housing portion further includes a guide pin projecting from the body accommodation portion or the connector accommodation portion in a direction orthogonal to the second direction,
the guide rail includes
an inlet groove extending in the second direction when the lever is in a first state, the inlet groove allowing the guide pin to enter the inlet groove during housing of the power storage device in the housing portion, and
a curved groove extending from the inlet groove in a pivot direction of the lever, and
the lever is configured to pivot from the first state to a second state to urge the curved groove in the second direction while further moving, relative to the guide rail, the guide pin that has entered the inlet groove through the curved groove.

19. The power supply apparatus according to claim 18, wherein
the guide rail further includes an extension groove extending, in the second state, from an end of the curved groove opposite to an inlet groove side in a direction intersecting the second direction, and
the lever is configured to slide from the second state in a direction opposite to a direction of extension of the extension groove from the curved groove to cause the guide pin to enter the extension groove from the curved groove relative to the guide rail.

20. An electrically-powered vehicle comprising the power supply apparatus according to claim 2.
